(19) United States
(12) Patent Application Publication
(10) Pub. No.: US 2007/0282958 A1
(43) Pub. Date: Dec. 6, 2007

(54) E-Mail Community System, Program And Recorded Medium

(75) Inventors: Ai Erikawa, Pasadena, CA (US); Shozo Ueno, Yokohama-shi (JP); Katsutoshi Kawada, Yokohama-shi (JP); Kenji Matsubara, Yokohama-shi (JP)

Correspondence Address: MARSH, FISCHMANN & BREYFOGLE LLP, 3151 SOUTH VAUGHN WAY, SUITE 411, AURORA, CO, 80014, US

(73) Assignee: KABUSHIKI KAISHA KOEI, Kanagawa-ken (JP)

(21) Appl. No.: 11/571,322

(22) PCT Filed: Jun. 28, 2004
(86) PCT No.: PCT/JP04/09106

§ 371 Date: May 21, 2007

(51) Int. Cl. G06F 15/16

(52) U.S. Cl. 709/206

(57) ABSTRACT

The object of the invention is to prevent problems, before they occur, in a multiple-participant network game wherein e-mails inside and outside the game can be communicated in cooperation with each other and wherein the game can be used with Internet e-mail addresses, which are personal information, not opened. To solve these problems the invention provides for an e-mail community system, which allows characters in a network game to communicate with each other, includes a step of permitting, when a sender uses a dedicated e-mail address, a receiver to use the dedicated e-mail address and an Internet e-mail address to perform transmission/reception; and a step of permitting, when the sender uses the Internet e-mail address, the receiver to use the dedicated e-mail address by automatically converting the Internet e-mail address into the dedicated e-mail address to perform transmission/reception. In addition, a program for causing the e-mail community system to function is prepared, and a computer-readable recording medium in which the program has been recorded is prepared.

### FIELD OF THE INVENTION

This invention relates to an e-mail community system, program, and recorded medium, and more particularly to an e-mail community system, program, and recorded medium to automatically convert, according to the circumstances, an ordinal Internet e-mail address and a dedicated e-mail address that is unique to a network game to transmit and receive communication irrespective of whether player who is operating terminal equipment is playing the network game or not. The players on the terminal equipment can transmit/receive the communication without being notified of the Internet e-mail address each other and without concern of the playing status of the other player.

### BACKGROUND OF THE INVENTION

Recently, there arose remarkable progress in communication technology and increasing number of Internet user owing to the widespread proliferation of broadband. With this progress, have become popular network games allowing many players to join the game at the same time through the network.

The network game includes a lobby server type and a multiple-participant MMORPG (Massively Multiplayer On-line Role Playing Game) type which allows many players to join.

In the lobby server type, a number of game players are divided into group of e.g. eight players, and a terminal equipment of one game player in each group is set as a host machine, and the terminal equipment of the rest of the game players of each group are set as client machines to share a single virtual space by one group.

A dedicated server of the center meditates transmitting and receiving of game commands of the terminal equipment in each group, while actual game program is executed on each terminal equipment.

On the other hand, in the multi-participant MMORPG type, a dedicated server of the center acting as a host machine executes actual main game programs, intensively administrates the virtual space the terminal equipment share, and proceeds the game by transmitting and receiving the game commands among the terminal equipment.

Further, in the network game of the MMORPG type, a number of players, such as thousands player, can connect to the high-specification dedicated server administrated by game provider to join the game, which has become popular in recent years.

Also in the network game of MMORPG type, the game proceeds while the players on the terminal equipment are operating characters representing players themselves in the virtual space. One of the characteristic features of the MMORPG network game is an e-mail feature as communication means between the characters.

Such e-mail feature is disclosed in JP Laid-Open No 2002-297509 hereunder called “document 1”.

Document 1 discloses processes carried out as follows:
(1) A terminal 1 (e.g. PDA, Personal Digital Assistant) transmits, to a server (lobby service server), a first e-mail for demanding a selection of game opponents to play with;
(2) The server stores a game ID contained in the received first e-mail as well as an e-mail address of the terminal 1 with those correlations;
(3) The server searches, from the stored data, an e-mail address of a terminal 2, other than that of terminal 1 having the identical game ID, as the opponent for the game;
(4) After the server found the e-mail address of the terminal 2, the terminal 1 transmits a second e-mail to the server for an execution of the game;
(5) The server converts the e-mail address of the terminal 1 contained as a sender (transmitter) in the received second e-mail into a different e-mail address (such as e-mail address of the server); and
(6) The server transmits the second e-mail to the terminal 2. The address of the sender is always converted (see paragraphs 0452, 0472, and 0498). The address of the receiver (destination address) is converted into e.g. the e-mail address of the server as indicated in paragraph 0481.

Also, as shown in FIG. 24, the e-mail address of the terminal 1, sender, is converted into “aaa.ne.jp”, while the e-mail destination address of the terminal 2, receiver, is converted into “server.co.jp”.

Also in the reference 1, when the player of the terminal 1 enters the address of the server displayed on the screen (“server.co.jp”) in a destination field of and transmits the e-mail, the server automatically converts the destination address and the e-mail is transmitted to the terminal 2 even if the player of the terminal 1 does not know the e-mail address of the opponent terminal 2 (“bbb.ne.jp”). It is noted that the server is notified of the address of the receiver (“bbb.ne.jp”) by the first e-mail.

Further, according to reference 1, while the sender's address (“aaa.ne.jp”) is transmitted as the mail source to the destination address, this address is converted by the server (into “server.co.jp”). On this account, it is the same as the present invention in that the receiver is not notified of the sender's address (“aaa.ne.jp”).

Reference 1 assumes the game is utilizing a standard e-mail (see paragraphs [0002-[0005], instead of the network game through ordinal WWW (World Wide Web) as in the present invention. All data regarding the game are transacted through the e-mail between the terminal and the game server.

In FIG. 24, although the address “server.co.jp” is still an address used in the game, the reference 1 does not obviously separate the e-mail community system into inside- and outside-games as in the present invention, rather treating the outside-game only.

The converted address of the reference 1 is described only as “server.co.jp”, and it is not the address allocated as a character ID (such as “001@ . . . ” and “002@ . . . ”) as in the present invention.

In reference 1, the address of the destination is only mentioned in paragraph

[0048]. It is understood that in transmitting, when a particular address (“server.co.jp”) is entered as the receiver's address and the e-mail is transmitted, the address should be automatically converted into the opponent's address (“bbb.ne.jp”) in advance found by the server and the e-mail should be sent to the destination. The reference 1 does not recite in this regard.

Just for reference, with regard to other communication features, terminal equipment (such as a personal computer, mobile phone, and PDA) operated by the player is connected to the Internet through dial-up line, Internet service provider (ISP), and the like.

If the e-mail received through the Internet has a domain address addressed to this mail server, the mail server stores the received e-mail in its mail box, or transfers to the other mail server if it does not have such domain address.

A program for displaying the text of the mail for editing, and transmitting/receiving the e-mail is called a mailer. Representative mailer is Outlook Express™ of Microsoft in U.S.

The mail server transmits and receives the e-mail with the mailer. Representative mail server program is Sendmail™ of Sendmail.

It is an SMTP (Simple Mail Transfer Protocol) that is a communication protocol widely used for the mailer to transmit the e-mail to the mail server and for transferring the e-mail between the mail servers. Also it is a POP3 (Post Office Protocol Version 3) that is widely used as a communication protocol for the mailer to receive the e-mail from the mail server.

Ports allocated for SMTP and POP3 are different, so that the mailer communicates with the mail server through the port allocated for SMTP in transmitting the e-mail and through the port allocated for POP3 in receiving the e-mail.

In a header of the transmitted e-mail, updated information is added thereto each time the mailer is transmitted through the mail server.

As in the ordinal letter, “From” filed in the header stores the sender's e-mail address, “To” filed the receiver's e-mail address, and “Subject” field a subject of the e-mail.

The mailer inserts the e-mail address of the sender into the “from” filed in the header. This e-mail address is also utilized as the address for reply.

There are some mailers that change the address for reply when “Reply-to” filed is set for the e-mail address for reply.

In order to transmit the e-mail, the mailer should be provided with proper setting of the e-mail address corresponding to the mailer and of a host name of the mail server compliant with the SMTP.

Based on the host name of the mail server compliant with the SMTP, the mailer transmits the e-mail to the mail server.

Domain name is described or indicated by name and property of organization and country code with an addition of a dot (e.g. “koei.co.jp”), and the e-mail address and the host name are described based on this domain name.

More particularly, the e-mail address is indicated by adding “@” mark as a separation letter to a user name, and the domain name is added thereto (e.g. “user@koei.co.jp”).

The host name is indicated by adding the dot as the separation letter to the server name, and the domain name is added thereto (e.g. “mailserver.koei.co.jp”).

In transmission of the e-mail, the mailer needs to obtain an IP (Internet Protocol) address that is allocated to the host.

The IP address is described by combination of numerals and dots, such as “192.168.0.3”.

Also a system to convert the host name into the IP address is a DNS (Domain Name System).

In the Internet, many DNS servers are provided and if the host name is transmitted to any DNS server, it replies the IP address that is allocated to the host name.

Before accessing to the mail server, the mailer receives the IP address of the mail server supplied from the DNS server.

Then following the protocol of the SMTP, the mailer transmits the e-mail to the mail server at the IP address.

In the present invention, the transmission of the e-mail from inside of the network game (also referred to as “inside-game”) to outside of the network game (also referred to as “outside-game”) is processed in the similar manner the ordinal mailer does.

More particularly, a format of the e-mail used inside the network game is a standard data format (header section plus body section) defined by a RFC (Request For Comment) 822, and required headers are added (data link layer addition header, IP header, and TCP header) to provide a certain packet format compliant with the TCP (Transmission Control Protocol)/IP (Internet Protocol).

When transmitting, the SMTP number is stored for a port number of the receiver in the TCP header. Opposite process is made for transmission from the outside to inside the network game.

The reference 1 however does not describe the above-mentioned features. That is, the reference 1 describes the conversion of the address in the “From” and “To” fields, which is a transmission/reception of the e-mail from outside to outside the network game mentioned in the present invention. This is simply a transmission of the standard e-mail. On this account, conversion of the e-mail data format and transferring to the ports are not changed, so that these are not to be considered.

### SUMMARY OF THE INVENTION

### Problems to be Solved by the Invention

In the conventional MMORPG network game, the e-mail addresses used inside and outside the game are obviously distinguished or separated.

This is because, while the player registered by the dedicated server is given a dedicated e-mail address exclusively used in the game (also referred to as “inside-game address”) and an account ID for identification of the player, only the dedicated e-mail address or the account ID is allowed to use for exchanging the e-mails in the game in order to eliminate the need to use the ordinal Internet addresses, which are personal information of the sender, to avoid careless notification (disclosure) of such Internet address to the opponent.

Due to such distinction, the e-mail can only be exchanged between the players who are playing the network game at present.

On the other hand, it is inconvenient that the e-mail cannot be directly exchanged between the player who is playing the network game and the player who is not playing.

More particularly, the network game must be initiated once to read and write the e-mail in the network game. If the player, who is wanted a relatively prompt communication in the network game, is not playing the network game at this moment, the opponent must interrupt or quit the game to start the mailer for transmitting the e-mail using the ordinal Internet e-mail address other than the network game, which is bothering.

In this regard, it is believed that one can enjoy the network game more by a free (unrestricted) exchange of the e-mails between inside and outside of the network game without leaking of the private information. For example, the player can instantly send the e-mail to friendly group to ask advice to deal with enemy characters in the network game, or to ask for gathering to start the battle in group.

The object of the present invention is to prevent problems, before they occur, in a multiple-participant network game wherein e-mails inside and outside the game can be communicated freely in cooperation with each other and wherein the e-mail can be used safely without disclosure of the Internet e-mail address, which are personal information, since harassing, stalking, and troublesome mailing can lead to a large problem to affect the administration of the game in the MMORPG network game.

### Means to Solve the Problems

In order to obviate above-mentioned inconveniences, the present invention provides an e-mail community system wherein, in a multiple-participant network game which the network game proceeds by intensively administrating the virtual space shared by a dedicated server and each terminal equipment and by transmission/reception between the dedicated server and the terminal equipment,
as the network game proceeds by operating a character displayed in the virtual space as an avatar representing the player himself of one terminal equipment, the players on the terminal equipment can communicate each other by using dedicated e-mail addresses that can be used only in the network game, comprising the step of:
   in communicating between the terminal equipment, when a sender uses the dedicated e-mail address routing through the dedicated server, permitting a receiver to transmit/receive the e-mail with the dedicated e-mail address routing through the dedicated server or with the Internet e-mail address not routing through the dedicated server; and
   in communicating between the terminal equipment, when the sender uses the Internet e-mail address not routing through the dedicated server, permitting the receiver to transmit/receive the e-mail with the dedicated e-mail address routing through the dedicated server by converting automatically the Internet e-mail address into the dedicated e-mail address.

In addition, the present invention provides a program to function as an e-mail community system wherein, in a multiple-participant network game which the network game proceeds by intensively administrating the virtual space shared by a dedicated server and each terminal equipment and by transmission/reception between the dedicated server and the terminal equipment,
as the network game proceeds by operating a character displayed in the virtual space as an avatar representing the player himself of one terminal equipment, the players on the terminal equipment can communicate each other by using dedicated e-mail addresses that can be used only in the network game, comprising:
in communicating between the terminal equipment, when a sender uses the dedicated e-mail address routing through the dedicated server, means for permitting a receiver to transmit/receive the e-mail with the dedicated e-mail address routing through the dedicated server or with the Internet e-mail address not routing through the dedicated server; and
in communicating between the terminal equipment, when the sender uses the Internet e-mail address not routing through the dedicated server, means for permitting the receiver to transmit/receive the e-mail with the dedicated e-mail address routing through the dedicated server by converting automatically the Internet e-mail address into the dedicated e-mail address.

Further, a computer-readable recording medium on which the program is recorded.

### EFFECTS OF THE INVENTION

According to the present invention, in the multiple-participant network game which the network game proceeds by intensively administrating the virtual space shared by the dedicated server and each terminal equipment and by transmission/reception between the dedicated server and the terminal equipment, as the network game proceeds by operating the character displayed in the virtual space as the avatar representing the player himself of one terminal equipment, the players on the terminal equipment can communicate each other by using dedicated e-mail addresses that can be used only in the network game, the present invention includes the step of: in communicating between the terminal equipment, when the sender uses the dedicated e-mail address routing through the dedicated server, permitting the receiver to transmit/receive the e-mail with the dedicated e-mail address routing through the dedicated server or with the Internet e-mail address not routing through the dedicated server; and in communicating between the terminal equipment, when the sender uses the Internet e-mail address not routing through the dedicated server, permit the receiver to transmit/receive the e-mail with the dedicated e-mail address routing through the dedicated server by converting automatically the Internet e-mail address into the dedicated e-mail address.

Accordingly, by this e-mail feature acting as the important role of communication in the multi-participant network game, the players on the network game (also referred to as “user”) can have more opportunity for communication, owing to association between the instant e-mail feature to be used in the network game routing through the dedicated server and the nearly-instant e-mail feature to be used outside the network game not routing through the dedicated server. (The outside game e-mail includes, but not limited to, the e-mail by using a mobile phone for receiving anytime anywhere as well as the e-mail using the personal computer.)

In addition, the e-mail community system converts between the Internet e-mail address, which is a private e-mail address, and the dedicated e-mail address, which includes a character ID of the network game, thereby avoiding the personal information to leak for safe communications.

In addition,
(1) For the transmission of the e-mail from the inside to outside game, the communication can be established with the user who is not playing the game at present. In the network game system of the prior art, the communication cannot be established until the game is interrupted or quitted to start the mailer.
(2) For the transmission of the e-mail from the outside to inside game, the user who cannot log in the game server at an inconvenient time can communicate with the other user who is playing the game right now.
(3) In case some trouble arose between the friendly users, the possibility that the troublesome user stalks or sends Internet e-mail to the other user can be reduced, since he is not notified of the private e-mail address of the other user.

According to the present invention, irrespective of whether the sender or receiver is playing the game or not (inside game or outside game), the e-mail address is automatically converted according to the present state (whenever the user is inside or outside the game) to perform transmission/reception without notifying of the private e-mail address to the opponent.

According to the present invention, in the multiple-participant network game which the network game proceeds by intensively administrating the virtual space shared by the dedicated server and each terminal equipment and by transmission/reception between the dedicated server and the terminal equipment, as the network game proceeds by operating the character displayed in the virtual space as the avatar representing the player himself of one terminal equipment, the players on the terminal equipment can communicate each other by using dedicated e-mail addresses that can be used only in the network game, the present invention provides the program to function as: in communicating between the terminal equipment, when the sender uses the dedicated e-mail address routing through the dedicated server, the means for permitting the receiver to transmit/receive the e-mail with the dedicated e-mail address routing through the dedicated server or with the Internet e-mail address not routing through the dedicated server; and in communicating between the terminal equipment, when the sender uses the Internet e-mail address not routing through the dedicated server, the means for permitting the receiver to transmit/receive the e-mail with the dedicated e-mail address routing through the dedicated server by converting automatically the Internet e-mail address into the dedicated e-mail address. Accordingly, by this e-mail feature acting as the important role of communication in the multi-participant network game, the players on the network game (also referred to as “user”) can have more opportunity for communication, owing to association between the instant e-mail feature to be used in the network game routing through the dedicated server and the nearly-instant e-mail feature to be used outside the network game not routing through the dedicated server. (The outside game e-mail includes, but not limited to, the e-mail by using a mobile phone for receiving anytime anywhere as well as the e-mail using the personal computer.)

In addition, the program of the e-mail community system controls for conversion between the Internet e-mail address, which is a private e-mail address, and the dedicated e-mail address, which includes the character ID of the network game, thereby avoiding the personal information to leak for safe communications.

In addition,
(1) For the transmission of the e-mail from the inside to outside game, the communication can be established with the user who is not playing the game at present. In the network game system of the prior art, the communication cannot be established until the game is interrupted or quitted to start the mailer.
(2) For the transmission of the e-mail from the outside to inside game, the user who cannot log in the game server at an inconvenient time can communicate with the other user who is playing the game right now.
(3) In case some trouble arose between the friendly users, the possibility that the troublesome user stalks or sends Internet e-mail to the other user can be reduced, since he is not notified of the private e-mail address of the other user.

According to the present invention, irrespective of whether the sender or receiver is playing the game or not (inside game or outside game), the e-mail address is automatically converted according to the present state (whenever the user is inside or outside the game) to perform transmission/reception without notifying of the private e-mail address to the opponent.

### BEST MODE FOR CARRYING OUT THE INVENTION

By such configured present invention, in communicating between the terminal equipment, when the sender uses the dedicated e-mail address routing through the dedicated server, the receiver can transmit/receive the e-mail with the dedicated e-mail address routing through the dedicated server or with the Internet e-mail address not routing through the dedicated server, and in communicating between the terminal equipment, when the sender uses the Internet e-mail address not routing through the dedicated server, the receiver can transmit/receive the e-mail with the dedicated e-mail address routing through the dedicated server by converting automatically the Internet e-mail address into the dedicated e-mail address. Accordingly, by this e-mail feature acting as the important role of communication in the multi-participant network game, the players on the network game (also referred to as “user”) can have more opportunity for communication, owing to association between the instant e-mail feature to be used in the network game routing through the dedicated server and the nearly-instant e-mail feature to be used outside the network game not routing through the dedicated server.

### BRIEF DESCRIPTION OF THE DRAWINGS

An embodiment of the present invention is described in detail as follows with reference to the drawings.

FIGS. 1-23 illustrate the embodiment of the present invention.

FIGS. 1-4 show an e-mail community system 2 of a multi-participant MMORPG network game.

### MORE DETAILED DESCRIPTION OF THE DRAWINGS

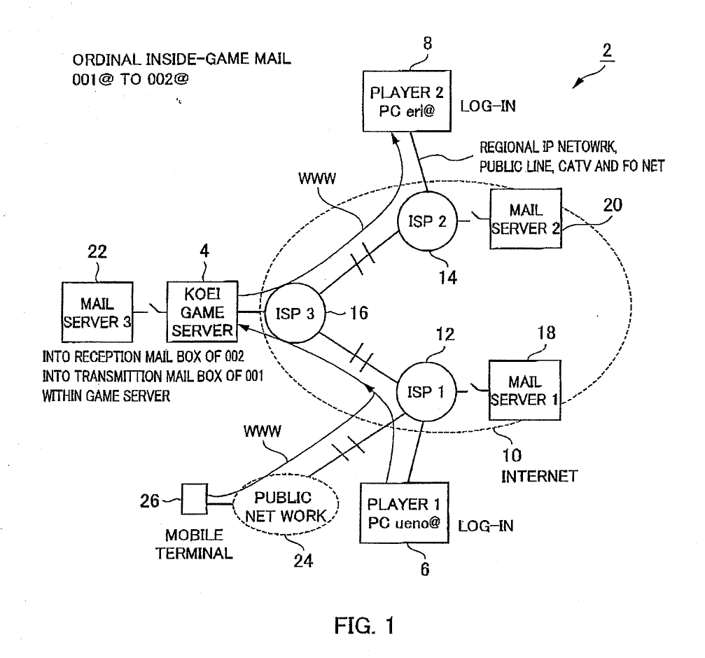

FIG. 1 is a schematic diagram for an ordinal inside-game mail according to an embodiment of the present invention.

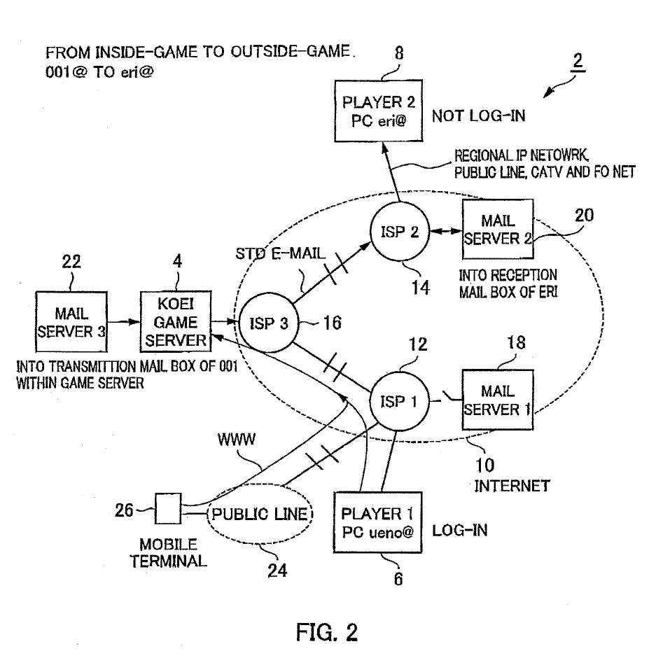

FIG. 2 is a schematic diagram for inside to outside-game mail.

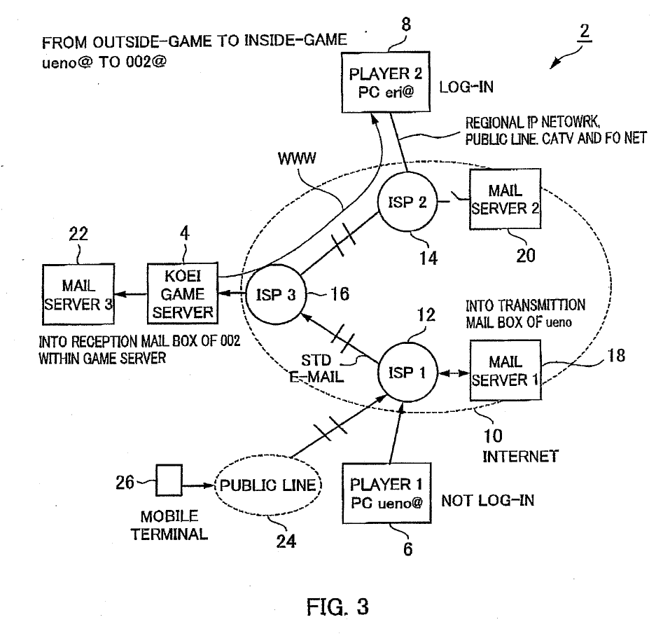

FIG. 3 is a schematic diagram for outside to inside-game mail.

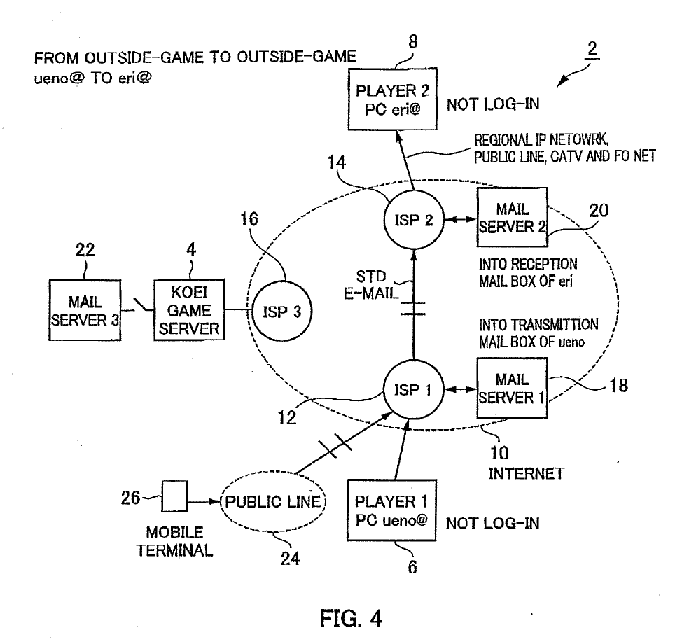

FIG. 4 is a schematic diagram for outside to outside-game mail.

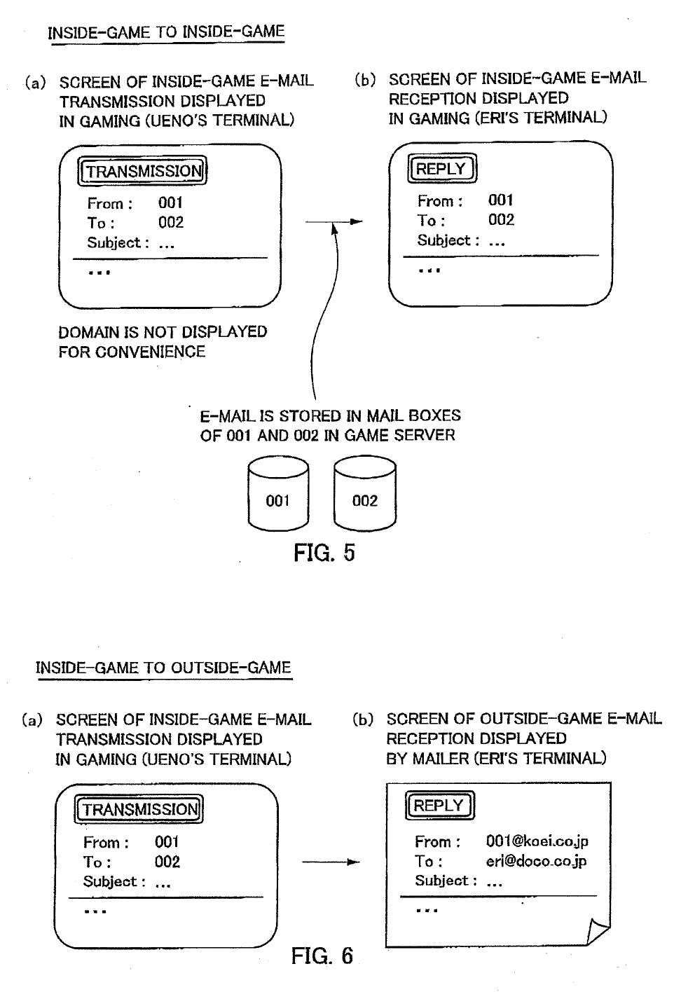

FIG. 5 is a schematic illustration for inside to inside-game mail, wherein FIG. 5(a) shows a screen for inside-game mail transmission displayed in gaming on Ueno's terminal, and FIG. 5(b) shows a screen for inside-game mail reception displayed in gaming on Eri's terminal.

FIG. 6 is a schematic illustration for inside to outside-game mail, wherein FIG. 6(a) shows a screen for inside-game mail transmission displayed in gaming on Ueno's terminal, and FIG. 6(b) shows a screen for outside-game mail reception displayed by the mailer on Eri's terminal.

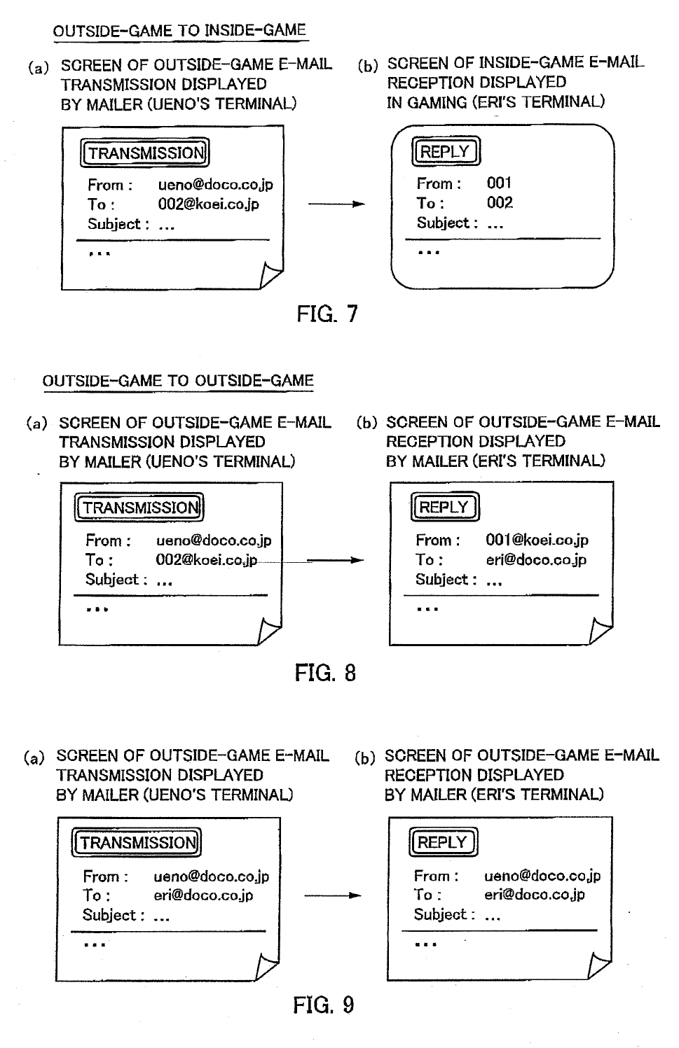

FIG. 7 is a schematic illustration for outside to inside-game mail, wherein FIG. 7(a) shows a screen for outside-game mail transmission displayed by the mailer on Ueno's terminal, and FIG. 7(b) shows a screen for inside-game mail reception displayed in gaming on Eri's terminal.

FIG. 8 is a schematic illustration for outside to outside-game mail, wherein FIG. 8(a) shows a screen for outside-game mail transmission displayed by the mailer on Ueno's terminal, and FIG. 8(b) shows a screen for outside-game mail reception displayed by the mailer on Eri's terminal.

FIG. 9 is a schematic illustration for ordinal outside to outside-game mail not routing through a dedicated server, wherein FIG. 9(a) shows a screen for outside-game mail transmission displayed by the mailer on Ueno's terminal, and FIG. 9(b) shows a screen for outside-game mail reception displayed by the mailer on Eri's terminal.

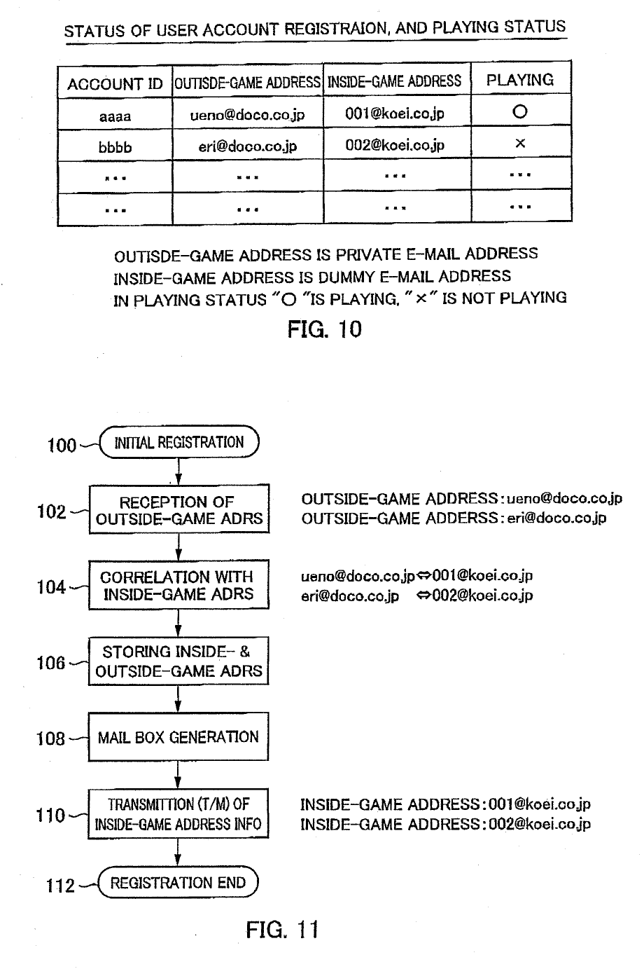

FIG. 10 is a diagram showing a status of user account registration and of playing state of the user.

FIG. 11 is a flowchart for initial registration.

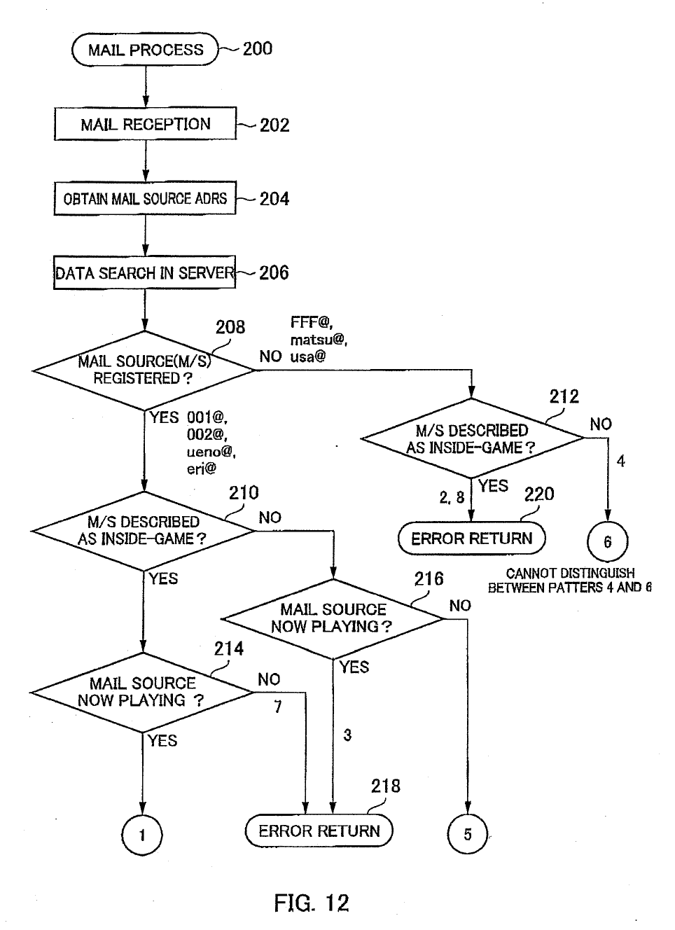

FIG. 12 is a flowchart for a mail process.

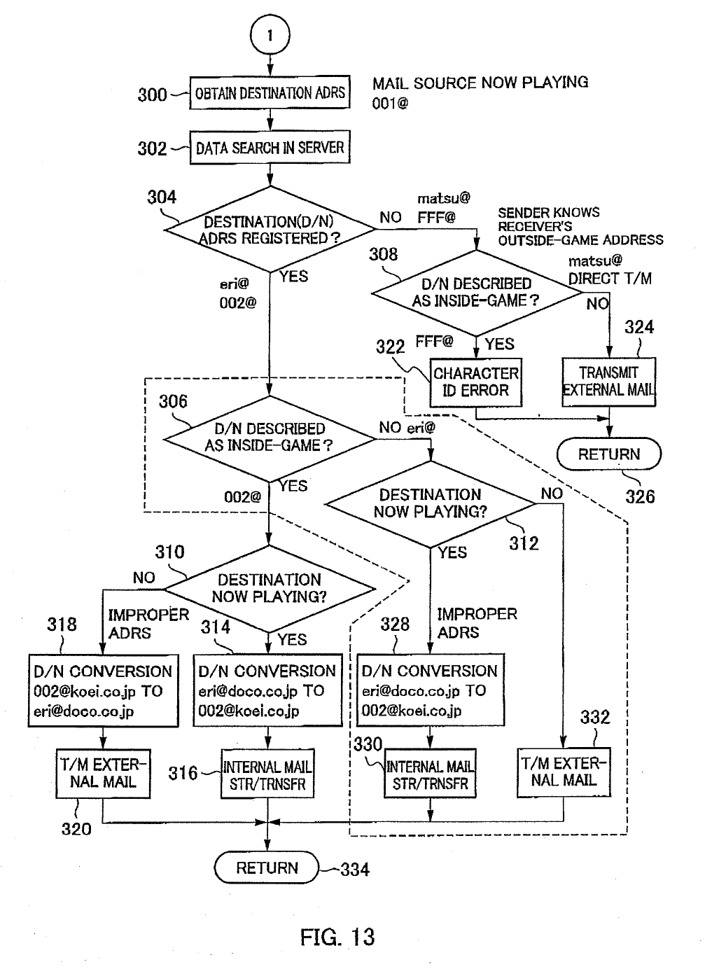

FIG. 13 is a flowchart for the case the sender (mail source) is playing the game (when using a dedicated mail address “001@”).

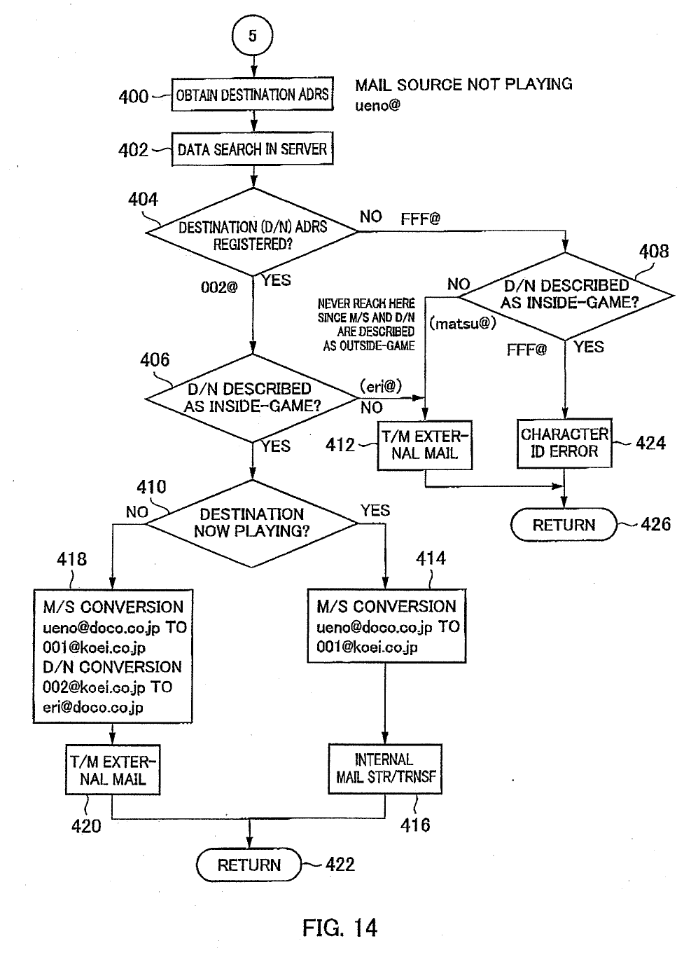

FIG. 14 is a flowchart for the case the sender is not playing the game (when using an Internet mail address “ueno@”).

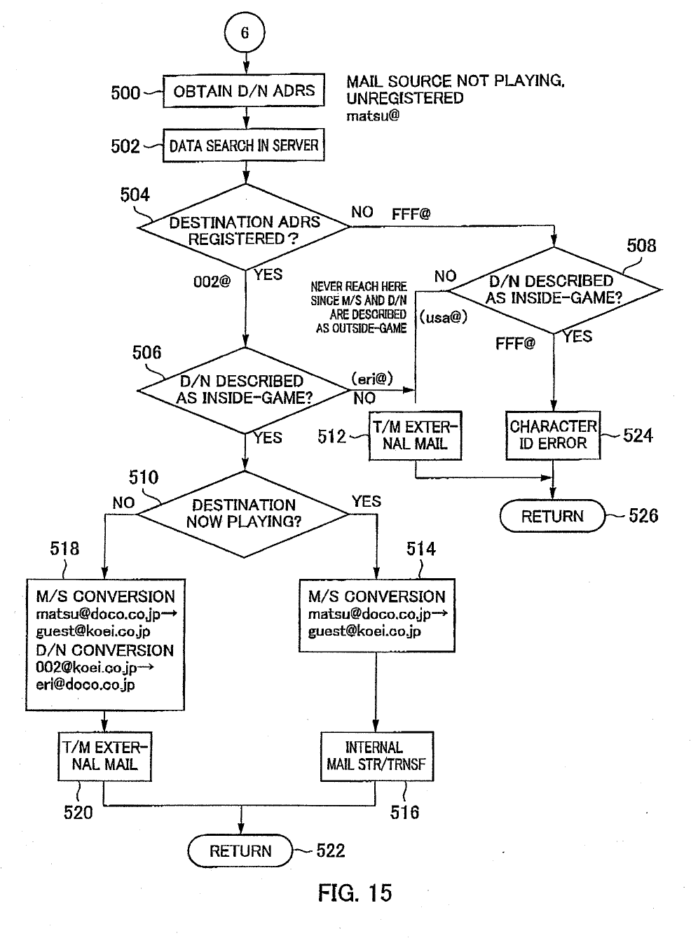

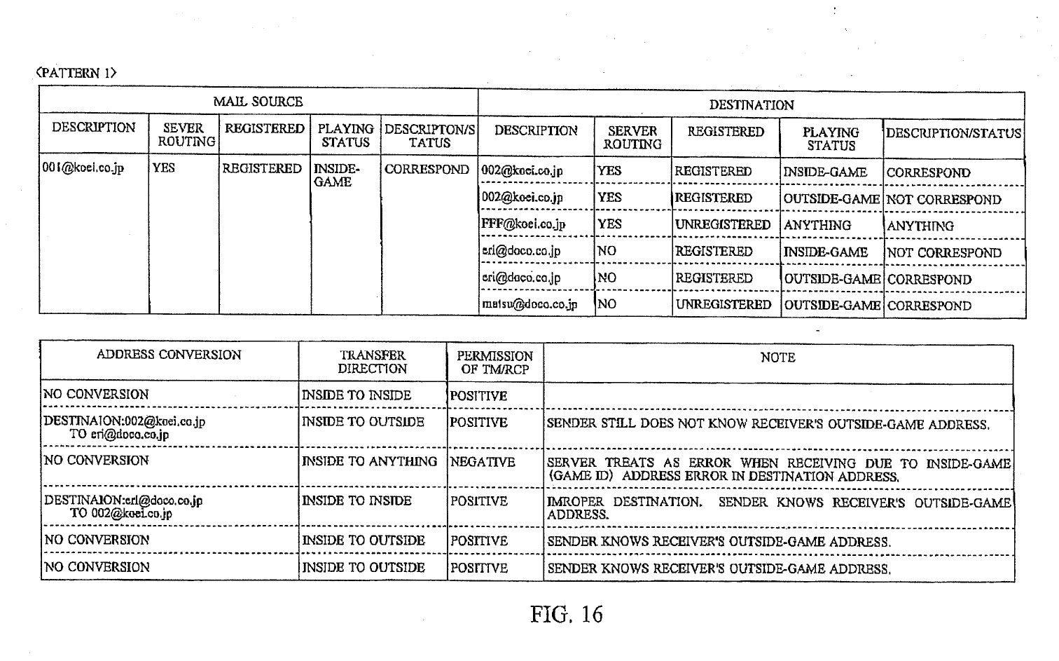

FIG. 15 is a flowchart for the case the sender is not playing the game (when using an Internet mail address “matsu@”).

FIG. 16 is an explanation for the case, in a communication between terminals, the sender (mail source) uses a registered inside-game address (dedicated e-mail address) routing through a dedicated server, <Pattern 1>.

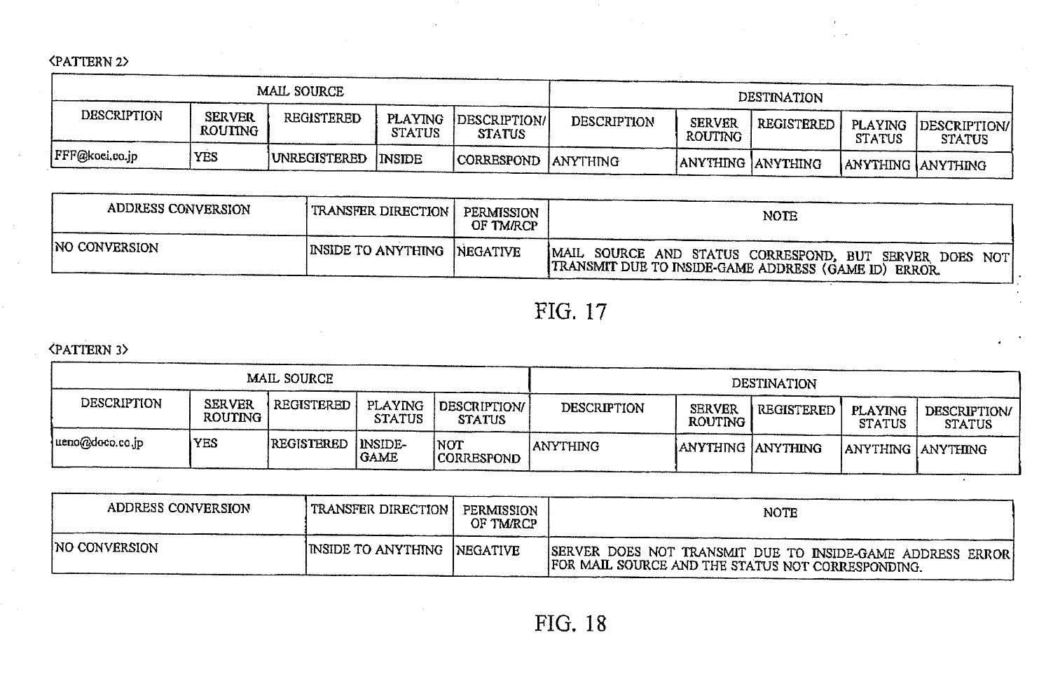

FIG. 17 is an explanation for the case, in a communication between terminals, the sender (mail source) uses an unregistered inside-game address (dedicated e-mail address) routing through a dedicated server, <Pattern 2>.

FIG. 18 is an explanation for the case, in a communication between terminals, the sender (mail source) uses a registered outside-game address (Internet e-mail address) routing through a dedicated server, <Pattern 3>.

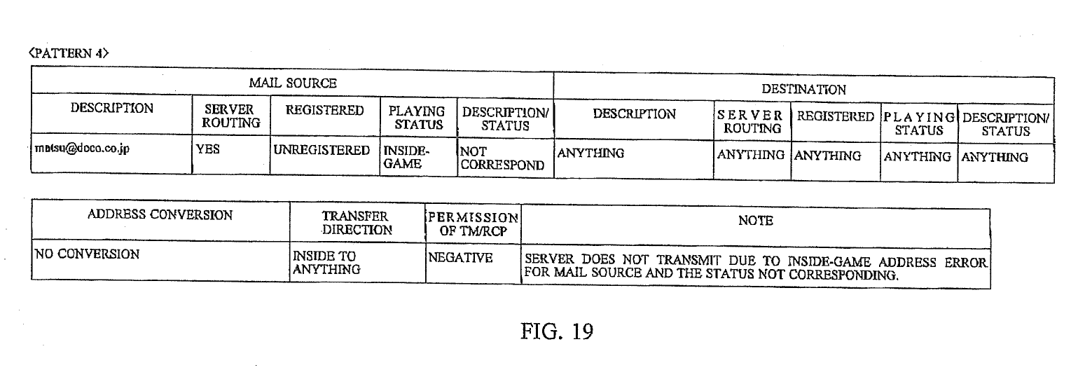

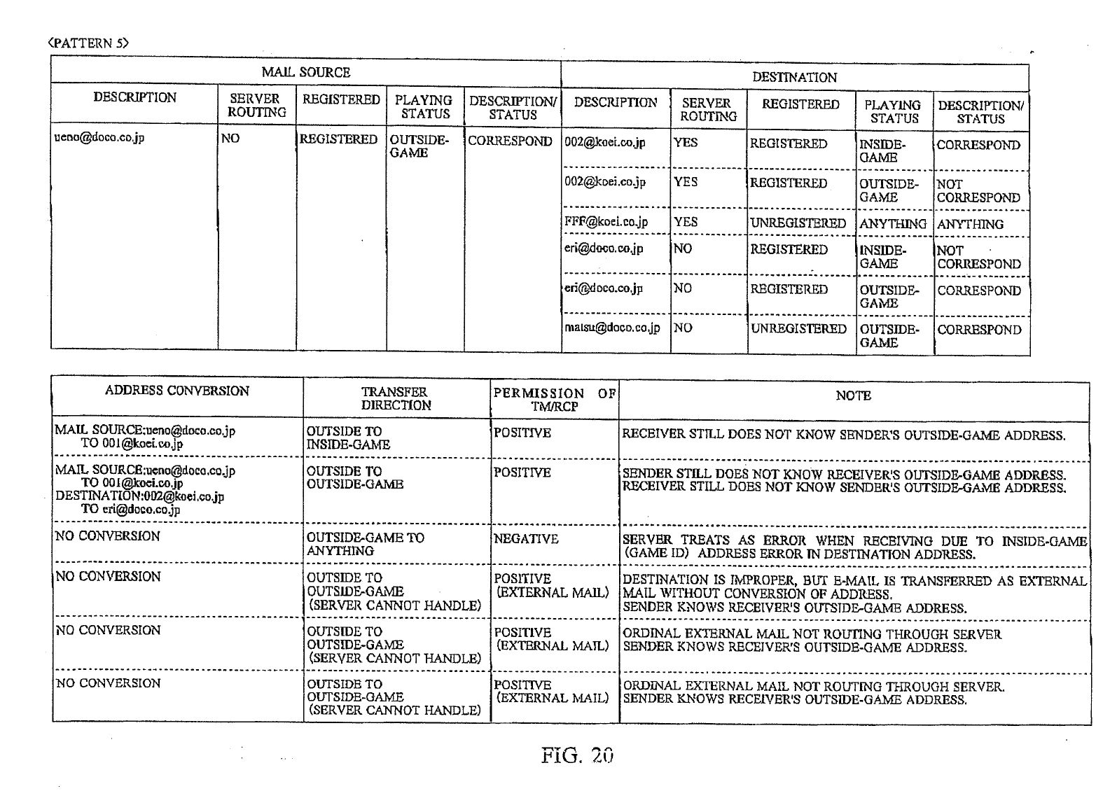

FIG. 19 is an explanation for the case, in a communication between terminals, the sender (mail source) uses an unregistered outside-game address (Internet e-mail address) routing through a dedicated server, <Pattern 4>.

FIG. 20 is an explanation for the case, in a communication between terminals, the sender (mail source) uses a registered outside-game address (Internet e-mail address) not routing through a dedicated server, <Pattern 5>.

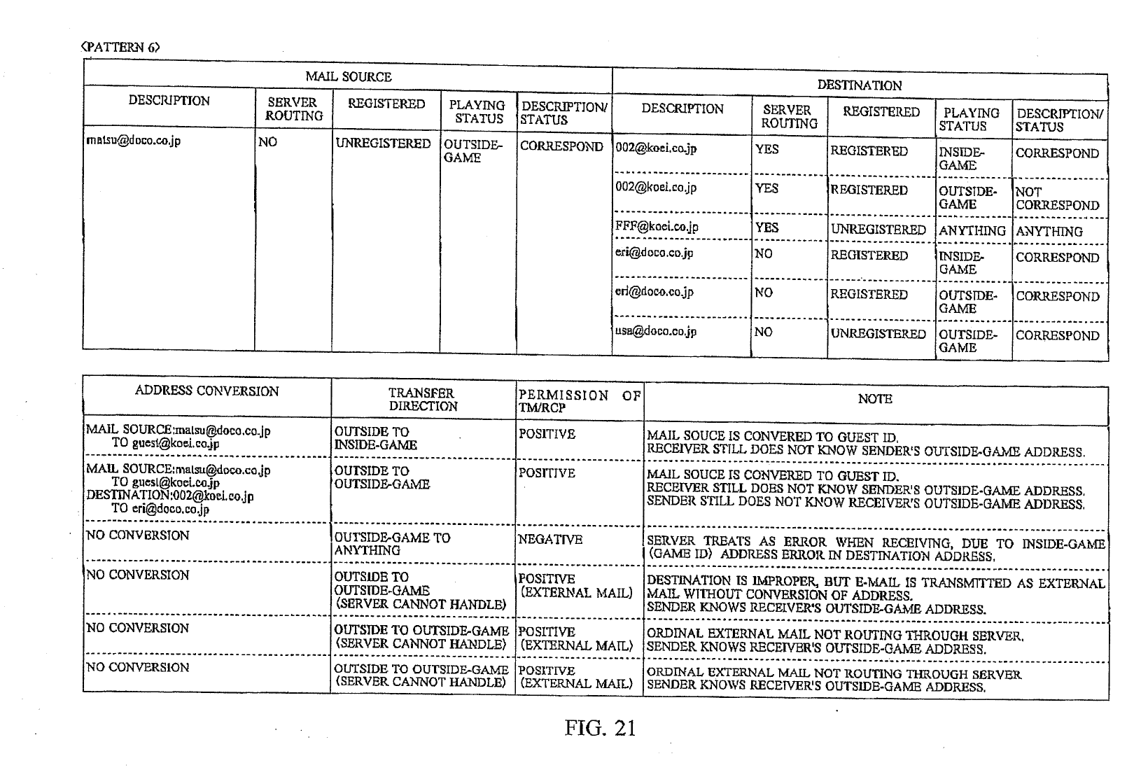

FIG. 21 is an explanation for the case, in a communication between terminals, the sender (mail source) uses an unregistered outside-game address (Internet e-mail address) not routing through a dedicated server, <Pattern 6>.

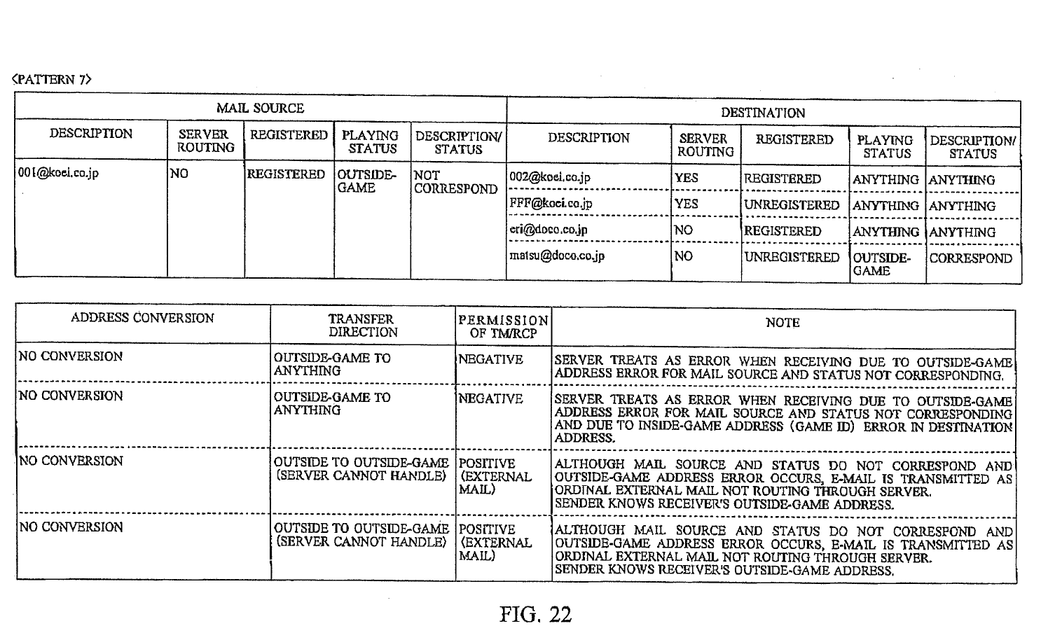

FIG. 22 is an explanation for the case, in a communication between terminals, the sender (mail source) uses a registered inside-game address (dedicated e-mail address) not routing through a dedicated server, <Pattern 7>.

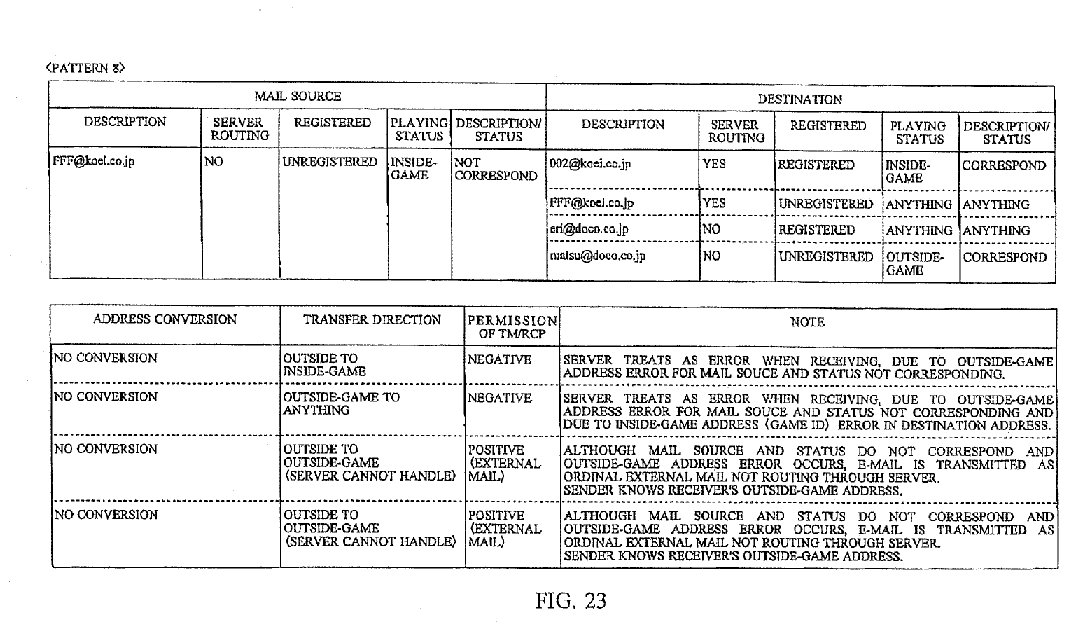

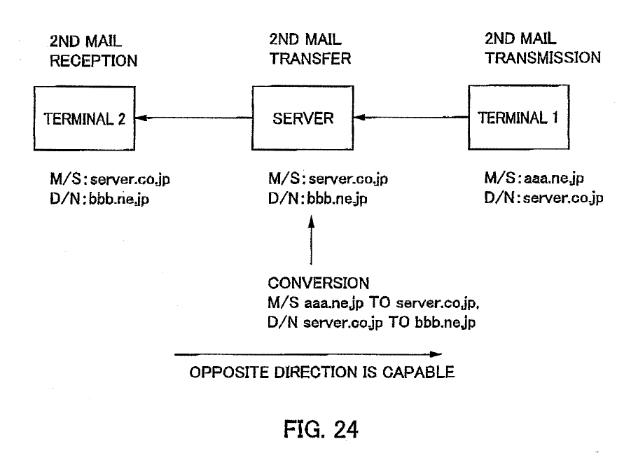

FIG. 23 is an explanation for the case, in a communication between terminals, the sender (mail source) uses an unregistered inside-game address (dedicated e-mail address) not routing through a dedicated server, <Pattern 8>.

FIG. 24 is a schematic illustration showing communication between server and terminals 1, 2 according to a prior art.

### DETAILED DESCRIPTION

The present invention is explained in detail with reference to the drawings.

In this multi-participant MMORPG network game, a dedicated server 4 (also referred to as “network game server”, “game server”, or just “server”) intensively administrates the virtual space shared by the server and each terminal equipment (also referred to as “PC” which includes personal computer, mobile phone, PDA, and the like in the present invention), and proceeds the game by performing transmission/reception among the dedicated server 4 and respective terminal equipment (e.g. a first terminal equipment 6 of a player 1 and a second terminal equipment 8 of a player 2).

In the multiple-participant network game as the network game proceeds by operating e.g. a character 1 displayed in the virtual space as an avatar representing the player 1 of the first terminal equipment 6, the e-mail community system 2 permits the player 1 on the first terminal equipment 6 to communicate with other character operated by e.g. the player 2 of the second terminal equipment 8 using a dedicated e-mail address that can be used only inside the network game, that is a communication between the characters.

As shown in FIGS. 1-4, the structure of the MMORPG network game includes on an Internet 10: a first Internet service provider (“ISP1”) 12 under contract with the player 1 operating the first terminal equipment 6; a second Internet service provider (“ISP2”) 14 under contract with the player 2 operating the second terminal equipment 8; a third Internet service provider (“ISP3”) 16 under contract with a network game provider (not shown) possessing the dedicated server 4; a first mail server (“mail server 1”) 18 connected to the first Internet service provider 12; a second mail server (“mail server 2”) 20 connected to the second Internet service provider 14; and a third mail server (“mail server 3”) 22 connected to the dedicated server 4.

Although it is described herein that the third Internet service provider (“ISP3”) 16 is under contract with the network game provider (not shown) possessing the dedicated server 4, the network game provider may act as the third Internet service provider 16.

To the Internet 10, a mobile terminal 26 can also connect through a public line network 24.

The e-mail community system 2 is configured to include the steps of: in communicating between the terminal equipment, when a sender uses the dedicated e-mail address routing through the dedicated server, permitting a receiver to transmit/receive the e-mail with the dedicated e-mail address routing through the dedicated server or with the Internet e-mail address not routing through the dedicated server; and in communicating between the terminal equipment, when the sender uses the Internet e-mail address not routing through the dedicated server, permitting the receiver to transmit/receive the e-mail with the dedicated e-mail address routing through the dedicated server by converting automatically the Internet e-mail address into the dedicated e-mail address.

More particularly, there are some patterns of communication between the first and second terminal equipment 6 and 8 as follows:

<Pattern 1>

the case where the sender uses registered inside-game address (dedicated e-mail address) as mail source routing through the dedicated server (see FIG. 16);
   <Pattern 2>
the case where the sender uses unregistered inside-game address (dedicated e-mail address) as mail source routing through the dedicated server (see FIG. 17);
   <Pattern 3>
the case where the sender uses registered outside-game address (Internet e-mail address) as mail source routing through the dedicated server (see FIG. 18);
   <Pattern 4>
the case where the sender uses unregistered outside-game address (Internet e-mail address) as mail source routing through the dedicated server (see FIG. 19);
   <Pattern 5>
the case where the sender uses registered outside-game address (Internet e-mail address) as mail source not routing through the dedicated server (see FIG. 20);
   <Pattern 6>
the case where the sender uses unregistered outside-game address (Internet e-mail address) as mail source not routing through the dedicated server (see FIG. 21);
   <Pattern 7>
the case where the sender uses registered inside-game address (dedicated e-mail address) as mail source not routing through the dedicated server (see FIG. 22); and
   <Pattern 8>
the case where the sender uses unregistered inside-game address (dedicated e-mail address) as mail source not routing through the dedicated server (see FIG. 23).

In case the sender uses the registered inside-game address (dedicated e-mail address) through the dedicated server (Pattern 1), as shown in FIG. 16, the playing status of the sender is “inside-game” and the receiver is classified as follows:
(1) the case where the sender uses registered inside-game address (dedicated e-mail address) of the receiver routing through the dedicated server when the playing status of the receiver is “inside-game”;
(2) the case where the sender uses registered inside-game address (dedicated e-mail address) of the receiver routing through the dedicated server when the playing status of the receiver is “outside-game”;
(3) the case where the sender uses unregistered inside-game address (dedicated e-mail address) of the receiver routing through the dedicated server when the playing status of the receiver is “anything (cannot specified)”;
(4) the case where the sender uses registered outside-game address (Internet e-mail address) of the receiver not routing through the dedicated server when the playing status of the receiver is “inside-game”;
(5) the case where the sender uses registered outside-game address (Internet e-mail address) of the receiver not routing through the dedicated server when the playing status of the receiver is “outside-game”; and
(6) the case where the sender uses unregistered outside-game address (Internet e-mail address) of the receiver not routing through the dedicated server when the playing status of the receiver is “outside-game”.
   Here, the description of the sender's address and status of the sender should be equivalent or corresponding, since the terminal equipment of the sender automatically describes the sender's address. However, the description of the receiver's address and status of the receiver may not correspond (improper description), since the sender can enter any address in the destination field.

As is clear from FIG. 16, in the <Pattern 1>:

transfer direction in case (1) is “inside-game to inside-game”, and permission of transmission/reception is “positive (transmission/reception is allowed)”;

transfer direction in case (2) is “inside-game to outside-game”, and permission of transmission/reception is “positive”; consequently the sender still does not know the outside game address of the receiver;

transfer direction in case (3) is “inside-game to anything”, and permission of transmission/reception is “negative”;

consequently the server treats it as an error when receiving the e-mail due to an inside game address (game ID) error in the description of the destination;

transfer direction in case (4) is “inside-game to inside-game”, and permission of transmission/reception is “positive”; consequently the description of the destination is improper (misdirection), the sender knowing the outside game address of the receiver;

transfer direction in the case (5) is “inside-game to outside-game”, and permission of transmission/reception is “positive”; consequently the sender knows the outside game address of the receiver; and

transfer direction in the case (6) is “inside-game to outside-game”, and permission of transmission/reception is “positive”; consequently the sender knows the outside game address of the receiver.

At this moment, the e-mail community system 2 of the present embodiment converts, in the case (2), the registered inside-game address (dedicated e-mail address) of the receiver into the registered outside-game address (Internet e-mail address), and converts, in the case (4), the registered outside-game address (Internet e-mail address) of the receiver into the registered inside-game address (dedicated e-mail address).

In the case of the above-mentioned <Pattern 2> where the sender uses the unregistered inside-game address (dedicated e-mail address) as the mail source routing through the dedicated server, as shown in FIG. 17, the playing status of the sender is “inside-game” and all elements of the receiver are designated as “anything”. The transfer direction for this case is “inside-game to anything” and the permission of transmission/reception is “negative”.

That is, the description of the sender's address and the status of the sender correspond, but the transmission through the server is not permitted due to an inside-game address (game ID) error.

In the case of the above-mentioned <Pattern 3> where the sender uses the registered outside-game address (Internet e-mail address) as the mail source routing through the dedicated server, as shown in FIG. 18, the playing status of the sender is “inside-game” and all elements of the receiver are designated as “anything”, which transfer direction for this case is “inside-game to anything” and the transmission/reception permission is “negative”.

That is, the transmission through the server is not permitted due to an inside-game address error since the description of the sender's address and the status of the sender does not correspond.

In the case of the above-mentioned <Pattern 4> where the sender uses the unregistered outside-game address (Internet e-mail address) as the mail source routing through the dedicated server, as shown in FIG. 19, the playing status of the sender is “inside-game” and all elements of the receiver are designated as “anything”. The transfer direction for this case is “inside-game to anything” and the permission of transmission/reception is “negative”.

That is, the transmission through the server is not permitted due to an inside-game address error since the description of the sender's address and the status of the sender do not correspond

In the case of the above-mentioned <Pattern 5> where the sender uses the registered outside-game address (Internet e-mail address) as the mail source not routing through the dedicated server, as shown in FIG. 20, the playing status of the sender is “outside-game” and the receiver is classified as follows:
(1) the case where the sender uses registered inside-game address (dedicated e-mail address) of the receiver routing through the dedicated server when the playing status of the receiver is “inside-game”;
(2) the case where the sender uses registered inside-game address (dedicated e-mail address) of the receiver routing through the dedicated server when the playing status of the receiver is “outside-game”;
(3) the case where the sender uses unregistered inside-game address (dedicated e-mail address) of the receiver routing through the dedicated server when the playing status of the receiver is “anything”;
(4) the case where the sender uses registered outside-game address (Internet e-mail address) of the receiver not routing through the dedicated server when the playing status of the receiver is “inside-game”;
(5) the case where the sender uses registered outside-game address (Internet e-mail address) of the receiver not routing through the dedicated server when the playing status of the receiver is “outside-game”; and
(6) the case where the sender uses unregistered outside-game address (Internet e-mail address) of the receiver not routing through the dedicated server when the playing status of the receiver is “outside-game”.

In <Pattern 5>, as is clear from FIG. 20:
transfer direction in the case (1) is “outside-game to inside-game”, and permission of transmission/reception is “positive (transmission/reception is allowed)”; consequently the receiver still does not know the outside game address of the sender;
transfer direction in the case (2) is “outside-game to outside-game”, and permission of transmission/reception is “positive”; consequently the sender still does not know the outside-game address of the receiver and the receiver does not know the outside-game address of the sender;
transfer direction in the case (3) is “outside-game to anything”, and permission of transmission/reception is “negative”; consequently the server treats it as an error when receiving the e-mail due to an inside game address (game ID) error in the description of the destination;
transfer direction in the case (4) is “outside-game to outside-game” (the server cannot handle), and permission of transmission/reception is “positive (as an external e-mail)”; consequently the description of the destination is improper, but the e-mail is directly transferred to such destination as an ordinal external e-mail without address conversion, since it is not routing through the dedicated server, the sender knowing the outside-game address of the receiver;
transfer direction in the case (5) is “outside-game to outside-game” (the server cannot handle), and permission of transmission/reception is “positive (as an external e-mail)”, which is the ordinal external e-mail since it is not routing through the dedicated server, the sender knowing the outside-game address of the receiver; and
transfer direction in the case (6) is “outside-game to outside-game” (the server cannot handle), and permission of transmission/reception is “positive (as an external e-mail)”, which is the ordinal external e-mail since it is not routing through the dedicated server, the sender knowing the outside-game address of the receiver.

At this moment, the e-mail community system 2 of the present embodiment converts, in the case (1), the registered outside-game address (Internet e-mail address) of the sender into the registered inside-game address (dedicated e-mail address), and converts, in the case (2), the registered outside-game address (Internet e-mail address) of the sender into the registered inside-game address (dedicated e-mail address) and also the registered inside-game address (dedicated e-mail address) of the receiver into the registered outside-game address (Internet e-mail address).

In the case of the above-mentioned <Pattern 6> where the sender uses the unregistered outside-game address (Internet e-mail address) as the mail source not routing through the dedicated server, as shown in FIG. 21, the playing status of the sender is “outside-game” and the receiver is classified as follows:
(1) the case where the sender uses registered inside-game address (dedicated e-mail address) of the receiver routing through the dedicated server when the playing status of the receiver is “inside-game”;
(2) the case where the sender uses registered inside-game address (dedicated e-mail address) of the receiver routing through the dedicated server when the playing status of the receiver is “outside-game”;
(3) the case where the sender uses unregistered inside-game address (dedicated e-mail address) of the receiver routing through the dedicated server when the playing status of the receiver is “anything”;
(4) the case where the sender uses registered outside-game address (Internet e-mail address) of the receiver not routing through the dedicated server when the playing status of the receiver is “inside-game”;
(5) the case where the sender uses registered outside-game address (Internet e-mail address) of the receiver not routing through the dedicated server when the playing status of the receiver is “outside-game”; and
(6) the case where the sender uses unregistered outside-game address (Internet e-mail address) of the receiver not routing through the dedicated server when the playing status of the receiver is “outside-game”.

In <Pattern 6>, as is clear from FIG. 21:
transfer direction in case (1) is “outside-game to inside-game”, and permission of transmission/reception is “positive (transmission/reception is allowed)”; consequently the description of the mail source is converted into guest ID, the receiver still not knowing the outside game address of the sender;
transfer direction in case (2) is “outside-game to outside-game”, and permission of transmission/reception is “positive”; consequently the description of the mail source is converted into guest ID, the receiver still not knowing the outside-game address of the sender, and the sender still not knowing the outside-game address of the receiver;
transfer direction in the case (3) is “outside-game to anything”, and permission of transmission/reception is “negative”; consequently the server treats it as an error when receiving the e-mail due to an inside game address (game ID) error in the description of the destination;
transfer direction in the case (4) is “outside-game to outside-game” (the server cannot handle), and permission of transmission/reception is “positive (as an external e-mail)”; consequently the description of the detonation is improper, but the e-mail is directly transferred to such destination as an ordinal external e-mail without address conversion, since it is not routing through the dedicated server, the sender knowing the outside-game address of the receiver;
transfer direction in the case (5) is “outside-game to outside-game” (the server cannot handle), and permission of transmission/reception is “positive (as an external e-mail)”, which is the ordinal external e-mail since it is not routing through the dedicated server, the sender knowing the outside-game address of the receiver; and
transfer direction in the case (6) is “outside-game to outside-game” (the server cannot handle), and permission of transmission/reception is “positive (as an external e-mail)”, which is the ordinal external e-mail since it is not routing through the dedicated server, the sender knowing the outside-game address of the receiver.

At this moment, the e-mail community system 2 of the present embodiment converts, in the case (1), by the privileges of the registrant, the registered outside-game address (Internet e-mail address) of the sender into the inside-game address (dedicated e-mail address), and converts, in the case (2), by the privileges of the registrant, the registered outside-game address (Internet e-mail address) of the sender into the registered inside-game address (dedicated e-mail address) and also the registered inside-game address (dedicated e-mail address) of the receiver into the registered outside-game address (Internet e-mail address).

In the case of the above-mentioned <Pattern 7> where the sender uses the registered inside-game address (dedicated e-mail address) as the mail source not routing through the dedicated server, as shown in FIG. 22, the playing status of the sender is “outside-game” and the receiver is classified as follows:
(1) the case where the sender uses registered inside-game address (dedicated e-mail address) of the receiver routing through the dedicated server when the playing status of the receiver is “anything”;
(2) the case where the sender uses unregistered inside-game address (dedicated e-mail address) of the receiver routing through the dedicated server when the playing status of the receiver is “anything”;
(3) the case where the sender uses registered outside-game address (Internet e-mail address) of the receiver not routing through the dedicated server when the playing status of the receiver is “anything”; and
(4) the case where the sender uses unregistered outside-game address (Internet e-mail address) of the receiver not routing through the dedicated server when the playing status of the receiver is “outside-game”.

In <Pattern 7>, as is clear from FIG. 22:
transfer direction in the case (1) is “outside-game to anything”, and permission of transmission/reception is “negative”; consequently the server treats it as an error when receiving the e-mail due to an outside-game address error since the description of the sender's address and the status of the sender do not correspond;
transfer direction in the case (2) is “outside-game to anything”, and permission of transmission/reception is “negative”; consequently the server treats it as an error when receiving the e-mail due to an outside-game address error (since the description of the sender's address and the status of the sender do not correspond) and due to an inside-game address (game ID) error in the description of the destination address;
transfer direction in the case (3) is “outside-game to outside-game (the server cannot handle)”, and permission of transmission/reception is “positive (as an external e-mail)”; consequently although the description of the sender's address and the status of the sender do not correspond and an outside-game address error occurs, the e-mail is transmitted as an ordinal external e-mail since the e-mail does not route through the dedicated server, the sender knowing the outside-game address of the receiver; and
transfer direction in case (4) is “outside-game to outside-game” (the server cannot handle), and permission of transmission/reception is “positive (as an external e-mail)”; consequently although the description of the sender's address and the status of the sender do not correspond and an outside-game address error occurs, the e-mail is transmitted as an ordinal external e-mail since the e-mail does not route through the dedicated server, the sender knowing the outside-game address of the receiver.

In the case of the above-mentioned <Pattern 8> where the sender uses the unregistered inside-game address (dedicated e-mail address) as the mail source not routing through the dedicated server, as shown in FIG. 23, the playing status of the sender is “inside-game” and the receiver is classified as follows:
(1) the case where the sender uses registered inside-game address (dedicated e-mail address) of the receiver routing through the dedicated server when the playing status of the receiver is “inside-game”;
(2) the case where the sender uses unregistered inside-game address (dedicated e-mail address) of the receiver routing through the dedicated server when the playing status of the receiver is “anything”;
(3) the case where the sender uses registered outside-game address (Internet e-mail address) of the receiver not routing through the dedicated server when the playing status of the receiver is “anything”; and
(4) the case where the sender uses unregistered outside-game address (Internet e-mail address) of the receiver not routing through the dedicated server when the playing status of the receiver is “outside-game”.

In <Pattern 8>, as is clear from FIG. 23:
transfer direction in case (1) is “outside-game to inside-game”, and permission of transmission/reception is “negative”; consequently the server treats it as an error when receiving the e-mail due to an outside-game address (game ID) error since the description of the sender's address and the status of the sender do not correspond;
transfer direction in case (2) is “outside-game to anything”, and permission of transmission/reception is “negative”; consequently the server treats it as an error when receiving the e-mail due to an outside-game address error (since the description of the sender's address and the status of the sender do not correspond) and due to an inside-game address (game ID) error in the description of the destination address;
transfer direction in case (3) is “outside-game to outside-game (the server cannot handle)”, and permission of transmission/reception is “positive (as an external e-mail)”; consequently although the description of the sender's address and the status of the sender do not correspond and an outside-game address error occurs, the e-mail is transmitted as an ordinal external e-mail since the e-mail does not route through the dedicated server, the sender knowing the outside-game address of the receiver; and
transfer direction in case (4) is “outside-game to outside-game” (the server cannot handle), and permission of transmission/reception is “positive (as an external e-mail)”; consequently although the description of the sender's address and the status of the sender do not correspond and an outside-game address error occurs, the e-mail is transmitted as an ordinal external e-mail since the e-mail does not route through the dedicated server, the sender knowing the outside-game address of the receiver.

As shown in FIG. 1, for the ordinal inside-game e-mail (transmission of the e-mail from “001@” to “002@”) in the e-mail community system 2, the dedicated server 4 and the first and second terminal equipment 6, 8 are connected though the WWW (World Wide Web) respectively.

At this moment, the first Internet service provider (ISP1) 12 under contract with the player 1 operating the first terminal equipment 6 and the first mail server (e-mail serer 1) 18 are disconnected. Also, the second Internet service provider (ISP2) 14 under contract with the player 2 operating the second terminal equipment 8 and the second mail server (e-mail serer 2) 20 are disconnected.

More particularly, for the ordinal inside-game mail (from “001@” to “002@”), the e-mail transmitted/received inside of the network game is not, in fact, the Internet e-mail (also simply referred to as “e-mail”), but an Internet communication through the WWW. The data are transmitted by HTTP (Hyper Text Transfer Protocol) through which browsers display the web pages, or by a protocol unique to the game. HTTP is a protocol between the server providing the information and the client receiving the information, which is a set of basic rules for exchanging the hyper text such as web pages, whereas the browser is an application software for viewing the web pages.

Further, as shown in FIG. 2, for the case of “inside game to outside game” (from “001@” to “eri@”) in the e-mail community system 2, the dedicated server 4 and the first terminal equipment 6 are connected though the WWW. Between the dedicated server 4 and the second terminal equipment 8, the Internet e-mail is utilized through the second and third Internet service providers 14, 16.

At this moment, the first Internet service provider (ISP1) 12 under contract with the player 1 operating the first terminal equipment 6 and the first mail server (e-mail serer 1) 18 are disconnected. In contrast, the second Internet service provider (ISP2) 14 under contract with the player 2 operating the second terminal equipment 8 and the second mail server (e-mail serer 2) 20 are connected.

That is, for the e-mail transmitted from inside game to outside game (from “001@” to “eri@”), the e-mail is transferred from the player 1 to the KOEI's game server as the Internet communication data through the WWW not as the Internet e-mail, whereas the e-mail is transmitted from the mail server 3 which belongs to the KOEI's game server to the player 2 as the Internet e-mail.

As shown in FIG. 3, for the e-mail from the outside-game to inside-game (from “ueno@” to “002@”), the e-mail is transmitted by the first and third Internet service providers 12, 16 from the first terminal equipment 6 to the dedicated server 4, and the dedicated server 4 and the second terminal equipment 8 are connected through the WWW.

At this moment, the first Internet service provider (ISP1) 12 under contract with the player 1 operating the first terminal equipment 6 and the first mail server (e-mail server 1) 18 are connected. In contrast, the second Internet service provider (ISP2) 14 under contract with the player 2 operating the second terminal equipment 8 and the second mail server (e-mail serer 2) 20 are disconnected.

More particularly, for the e-mail transmitting from the inside-game to outside-game (from “ueno@” to “002@”), the mail is transmitted as the Internet e-mail by the mailer from the player 1 to the mail server 3 possessed by the KOEI's game server, and the e-mail is then transmitted as the Internet communication through the WWW from the KOEI's game server to the player 2.

As shown in FIG. 4, for the e-mail from the outside-game to outside-game (from “ueno@” to “eri@”), the e-mail is transmitted not by the WWW but by the first and second Internet service providers 12, 14 between the first and second terminal equipment 6 and 8.

At this moment, the first Internet service provider (ISP1) 12 under contract with the player 1 operating the first terminal equipment 6 and the first mail server (e-mail serer 1) 18 are connected. Also the second Internet service provider (ISP2) 14 under contract with the player 2 operating the second terminal equipment 8 and the second mail server (e-mail serer 2) 20 are connected.

Here, the explanation is provided as to an initial registration of the e-mail community system 2 required to initiate the MMORPG network game.

In this initial registration, the player 1 (e.g., Ueno) who is operating the first terminal equipment 6 and the player 2 (e.g., Erikawa) who is operating the second terminal equipment 8 are respectively required to register the outside-game addresses (Internet address) to the e-mail community system 2 for the MMORPG network game (for example, Ueno's outside-game address is ueno@doco.co.jp, and Erikawa's outside-game address is eri@doco.co.jp).

After registration of the outside-game addresses (Internet address), the e-mail community system 2 for the MMORPG type network game issues to Ueno and Erikawa the dedicated e-mail addresses as follows which are the inside-game address that can be used only within the game system. The inside-game address for Ueno is 001@koei.co.jp, and that for Erikawa is 002@koei.co.jp. Incidentally, term “Koei” used herein derives from the registered trademark owned by the applicant (Japanese trademark registration No. 2,460,358).

Then, the e-mail community system 2 stores the correlation between the inside and outside game addresses, i.e. dedicated e-mail address and Internet e-mail address, in a table for an e-mail address conversion.

The inside-game address is described as <character ID>@<address domain proper to the game>. Here, the address domain proper to the game is designated as “koei.co.jp”.

The status of transmission in the e-mail community system 2 is classified as follows.

A. Transmission of e-mail from outside-game

(1) When Ueno outside the game sends e-mail to Erikawa, making a prediction that Erikawa may be inside the game right now, the description of the addresses should be as follows.
   Mail source (sender): ueno@doco.co.jp
   Destination (receiver): 002@koei.co.jp
   At this moment, Ueno knows Erikawa's inside-game address “002@koei.co.jp”.
(2) The e-mail community system 2 checks the mail source and converts the sender's address into the inside-game address as follows since the sender's address is described as the outside-game address.
   Mail source (sender): 001@koei.co.jp
   Destination (receiver): 002@koei.co.jp
(3) Then the e-mail community system 2 determines as to whether or not receiver Erikawa is now inside the game (playing the game).
(4) If this determination is positive (the receiver is playing the game right now), the address of the receiver is not changed and Erikawa inside the game receives the e-mail from Ueno outside the game (transmission outside-game to inside-game).
   Mail source (sender): 001@koei.co.jp
   Destination (receiver): 002@koei.co.jp
   At this moment, receiver Erikawa is not notified of the sender Ueno's outside-game address (“ueno@doco.co.jp”). Sender Ueno is not notified of the receiver Erikawa's outside-game address (“eri@doco.co.jp”), either.
(5) If the check result is negative (the receiver is outside the game), the receiver Erikawa's address is converted into the outside-game address from the inside-game address as follows.
   Mail source (sender): 001@koei.co.jp
   Destination (receiver): eri@doco.co.jp
   At this moment, Erikawa outside the game receives the e-mail from Ueno outside the game (transmission from outside-game to outside-game). Receiver Erikawa is not notified of the sender Ueno's outside-game address (“ueno@doco.co.jp”). Sender Ueno is not notified of the receiver Erikawa's outside-game address (“eri@doco.co.jp”), either.
      B. Transmission of e-mail from inside-game
(1) When Erikawa inside the game sends the e-mail to Ueno, making a prediction that Ueno may be inside the game right now, the description of the addresses should be as follows.
   Mail source (sender): 002@koei.co.jp
   Destination (receiver): 001@koei.co.jp
   This is the case where Erikawa knows the Ueno's inside-game address (“001@koei.co.jp”).
(2) Then the e-mail community system 2 checks the destination address and determines as to whether or not receiver Ueno is now inside the game (playing the game).
(3) If this determination is positive (receiver is inside the game), the addresses of the sender and the receiver are not changed, and Ueno inside the game receives the e-mail from Erikawa inside the game (transmission from inside-game to inside-game).
   Mail source (sender): 002@koei.co.jp
   Destination (receiver): 001@koei.co.jp
(4) If the determination is negative (the receiver is outside the game), the destination address of Ueno is converted into the outside-game address from the inside-game address. Address of the sender is not changed. Ueno outside the game receives the e-mail from Erikawa inside the game (transmission from inside-game to outside-game).
   Mail source (sender): 002@koei.co.jp
   Destination (receiver): ueno@doco.co.jp
   At this moment, receiver Ueno is not notified of the sender Erikawa's outside-game address (“eri@doco.co.jp”). Sender Erikawa is not notified of the receiver Ueno's outside-game address (“ueno@doco.co.jp”).
(5) Incidentally, the dedicated e-mail address (inside-game address), i.e. e-mail address for the game, is issued after the registration of the Internet e-mail address (outside-game address) which is a private e-mail address, and this dedicated e-mail address is described to include character ID of the player's character equivalent to the player of the terminal. Mail boxes based on setting of the inside-game address for each player are generated on the game server or on the mail server connected thereto. Thereby, plural players can be designated as receivers at the same time when entering the destination for the e-mail transmission.
   C. The other cases
   (1) It is believed that there are many methods such as, while the receiver's e-mail address is designated as “daikoukai-online@koei.co.jp” which is a common address, the receiver's terminal equipment ID or character ID is included (a) in the subject, or (b) in the text as a tag.
   D. Example of the case the game is proceeding
   (1) Prior art
   AT NOON,
Player A thinks, “I want to have an adventure with player B tonight.”
Player A thinks, “I have not logged in yet, so I′ll send an e-mail after log-in.”
Player B thinks, “I cannot log-in, because I have things to do.”
   LATE AT NIGHT,
Player A thinks, “I can't play with player B because he has not logged in yet at this hour of the night.”
   NEXT DAY,
Player A asks player B, “Why didn't you log in yesterday? I waited for you.”
Player B replays, “Sorry, I couldn't log-in because I had things to do yesterday.”
   (2) According to the e-mail feature of the present invention using mobile e-mail
   AT NOON,
Player A thinks, “I want to have an adventure with player B tonight.”
Player A thinks, “I am going to write an e-mail.”
(The e-mail is transmitted from outside-game to the outside-game.)
Player B thinks, “Here is an invitation from player A for the adventure. But I can't log-in because I have things to do today.”
Player B thinks, “I should replay by e-mail.”
(The e-mail is transmitted from outside-game to the inside-game.)
Player A thinks, “Oh, player B can't play today. So I should play with player C.”
   NEXT DAY,
Player A mentions, “I played with Player C yesterday.”
Player B replies, “Oh did you. It's good you did not wait for me. I can play with you today.”
   E. What is displayed on the screen in proceeding by the e-mail community system 2 is explained as follows.
   (1) Transmission of e-mail from inside-game to inside-game As shown in FIG. 5(a), the Ueno's terminal displays the screen for transmission of the inside-game mail in gaming as follows.
From: 001
To: 002
Subject: . . .

As shown in FIG. 5(b), the e-mail is stored in the mail boxes of the sender (001@koei.co.jp) and receiver (002@koei.co.jp) in the game server, i.e. dedicated server. As shown in FIG. 5(b), the Eri's terminal displays the screen for reception of the inside-game mail in gaming as follows.
From: 001
To: 002
Subject: . . .
   (2) Transmission of e-mail from inside-game to outside-game.

As shown in FIG. 6(a), the Ueno's terminal displays the screen for transmission of the inside-game mail in gaming as follows.
From: 001
To: 002
Subject: . . .

As shown in FIG. 6(b), the Eri's terminal displays the screen for reception of the outside-game mail by the mailer as follows:
From: 001@koei.co.jp
To: eri@doco.co.jp
Subject: . . .

This is the case where the description of the receiver's address is eventually improper (Ueno inside the game knows Eri's outside-game address, but Ueno thought Eri is now inside the game, or Ueno does not know the Eri's outside-game address and in fact Eri is outside the game).

(3) Transmission of e-mail from outside-game to inside-game e-mail.

As shown in FIG. 7(a), the Ueno's terminal displays the screen for transmission of the outside-game mail by the mailer as follows.
From: ueno@doco.co.jp
To: 002@koei.co.jp
Subject: . . .

As shown in FIG. 7(b), the Eri's terminal displays the screen for reception of the inside-game mail in gaming as follows.
From: 001
To: 002
Subject: . . .
   (4) Transmission of e-mail from outside-game to outside-game.

As shown in FIG. 8(a), the Ueno's terminal displays the screen for transmission of the outside-game mail by the mailer as follows.
From: ueno@doco.co.jp
To: 002@koei.co.jp
Subject: . . .

As shown in FIG. 8(b), the Eri's terminal displays the screen for reception of the outside-game mail by the mailer as follows.
From: 001@koei.co.jp
To: eri@doco.co.jp
Subject: . . .

This is the case where the description of the receiver's address is eventually improper (Ueno inside the game knows Eri's outside-game address, but Ueno thought Eri is now inside the game, or Ueno does not know the Eri's outside-game address and in fact Eri is outside the game). Although this is a transmission of the e-mail from outside to outside game, the address can be converted since the e-mail routes through the server.

However, in case the Ueno's terminal displays the screen for transmission of the outside-game mail by the mailer such as “From: ueno@doco.co.jp/To: eri@doco.co.jp/Subject: . . . ” as shown in FIG. 9(a) and the Eri's terminal displays the screen for reception of the outside-game mail by the mailer such as “From: ueno@doco.co.jp/To: eri@doco.co.jp/Subject: . . . ” as shown in FIG. 9(b), it is a transmission from the ordinal outside-game to outside-game not routing thorough the server.

(5) FIG. 10 illustrates states of registration of user account and status of user playing the game. The outside-game address is the Internet e-mail address, which can be referred to as “private e-mail address” in other words. The inside-game address is the dedicated e-mail address, which can be referred to as “dummy e-mail address” in other words.

The dedicated server 4 is explained in addition as follows.

The dedicated server 4 is a network game server capable of exchanging the dummy e-mail which can be used only in the network game through the Internet communication by the WWW and the standard e-mail of the regular data format irrelevant to the game. The dedicated server 4 includes: user account registration means in which the dedicated server 4 receives the private e-mail address corresponding to the external terminal (such as the first and second terminal equipment 6 and 8) connected thereto through the Internet 10, generates a dummy e-mail address containing the numeral of the character operated by the outside terminal equipment in gaming, correlates the dummy e-mail address to the received private e-mail address, and memorizes this correlation or corresponding; playing status administration means in which the dedicated server 4 receives and memorizes the information sent by the external terminal indicating that the user is playing the game at the beginning of the game, and receives the information indicating that the game is ended at the end of the game, followed by erasing the information indicating that the user is playing so as to administrate the status of the user playing the game for each private game address corresponding to the external terminal; e-mail reception means in which the dedicated server 4 stores the dummy e-mail from the external terminal through the Internet communication by the WWW, or receives and stores the standard e-mail through the mail server (such as first and second mail servers 18 and 20); sender's e-mail address conversion means in which the dedicated server 4 obtains the sender's e-mail address contained in the data of the dummy e-mail or standard e-mail received by the e-mail reception means, determines whether or not the external terminal corresponding to the received sender's e-mail address is playing the game based on the playing status administrated by the playing status administration means, and converts, if it is determined to be a non-playing status, the sender's e-mail address into the dummy e-mail address stored by the user account registration means; and e-mail transmission means in which if the destination e-mail address of the e-mail is indicated as the private e-mail address, the dedicated server transmits the e-mail as a standard e-mail to the terminal equipment corresponding to the destination e-mail address, and if the destination e-mail address of the e-mail is indicated as the dummy e-mail address, the dedicated server transmits the e-mail to the external terminal corresponding to the destination e-mail address through the Internet communication by the WWW not routing through the mail server.

In addition, the dedicated server 4 or the network game server includes e-mail destination address conversion means in which the dedicated server obtains the e-mail address of the receiver contained in the data of the dummy e-mail or standard e-mail received by the e-mail reception means, determines whether or not the external terminal corresponding to the received receiver's e-mail address is playing the game based on the playing status administrated by the playing status administration means, converts, if it is determined to be the playing status, the destination e-mail address into the dummy e-mail address stored by the user account registration means, and converts, if it is determined to be a non-playing status, the destination e-mail address into the private e-mail address stored by the user account registration means.

Further, the dedicated server 4 or the network game server, includes an e-mail format conversion means in which if the e-mail destination address converted by the e-mail destination address conversion means is indicated as the private e-mail address, the dedicated server converts the data of the e-mail into those of a standard data format, and if the converted e-mail destination address is indicated as the dummy e-mail address, the dedicated server converts the data of the e-mail into those of an inside-game data format.

The operation of the present invention is explained with reference to a flowchart for the initial registration in FIG. 11.

A program for the initial registration of the e-mail community system 2 starts at step 1[00, and the process goes to step 102 for reception of the outside-game address. In this step 102, outside-game address (such as “ueno@doco.co.jp” and “eri@doco.co.jp”) is received.

Then the program goes to step 104 for correlating with the inside-game address. In this step 104, the received outside-game address is correlated with the inside-game address.

For example, the outside-game address “ueno@doco.co.jp” is correlated with inside-game address “001@koei.co.jp”, and the outside-game address “eri@doco.co.jp” is correlated with inside-game address “002@koei.co.jp”.

After the correlation in step 104, a process for memorizing the inside and outside game addresses is executed at step 106, followed by a process for generating the mail box at step 108 and a process for transmission of information on the inside-game address at step 110.

The step 110 is a process for reply the inside-game address that was correlated with the received outside-game address, such as inside-game address “001@koei.co.jp” and “002@koei.co.jp”.

After the step 110, the process goes to an ending of the initial registration at step 112.

Just for reference as to registration of the e-mail address, the user at first needs to register for a user registration in order to play the network game.

The use registration is required only at the first time the user plays the game, and the private information of the user is recorded in the game server of the game supplier.

In particular, at the first time the user plays the game, the user's terminal displays the screen for a user account registration (not shown).

Following the displayed instructions, the user enters the private information such as address, sex, and age as well as the outside-game address, and then selects a character that can be operated in gaming (player character) to meet the user's taste. The entered information is transmitted to the game server.

The game server receives the information and initiates for the process of the user initial registration.

The game server issues the selected player character with an identification number (character ID). The game server records in a database the correlation between the inside- and outside-game addresses (see FIG. 10), the inside-game address being composed of the character ID and a proper domain address. Then the mail boxes for the corresponding inside-game address are generated in the mail server and the game server. The user on the terminal is notified of the inside-game address by transmission of such information, and will be able to use the inside-game address in the game and to operate the selected player character.

The present invention as explained permits the user to select only a single player character and as correlating a single outside-game address with a single issued inside-game address. However, the present invention is not limited to this and many characters can be selected at the same time.

When the user is allowed to select more than one player character at the same time, more than one inside-game address must be issued since there may be no choice but to issue more than one character ID.

However, the outside-game address is proper to the user, so that it requires plural correlations between the inside- and outside-game addresses, which make it impossible to identify the player character when using only the outside-game address.

On this account, by issuing a particular identification number (player ID) proper to the player and describing the player ID to include the character ID of the inside-game address, and by indicating the character ID in the subject of the e-mail, the user can distinguish which character of the player sent the e-mail.

The operation of the present invention is explained with reference to the flowchart for processing the e-mail of FIG. 12.

An e-mail processing program of the e-mail community system 2 starts at step 2[00, followed by a process for reception of the e-mail at step 202, a process for obtaining the sender's address (mail source) at step 204, and a process for searching the data in the server at step 206.

After the process at step 206, it is determined at step 208 as to whether the sender's address has already been registered or not. If the determination at step 208 is “YES” (e.g. the inside- and outside-game addresses “001@koei.co.jp”, “002@koei.co.jp”, “ueno@doco.co.jp”, and “eri@doco.co.jp” have already been registered), another determination is made at step 210 as to whether the sender's address is described as the inside-game address or not. If the determination at step 208 is “NO”, then another determination is made at step 212 as to whether the sender's address is described as the inside-game address.

If the determination at step 210 is “YES”, then a determination is made at step 214 as to whether the mail source (i.e. sender) is playing the game now. If the determination at step 210 is “NO”, then it is determined at step 216 whether the mail source (i.e. sender) is playing the game.

If the determination at step 214 is “YES”, the process shifts to a process of <Pattern 1> (see FIGS. 13 and 16). If the determination at step 214 is “NO”, the process shifts to a process to return for error (see FIG. 22 <Pattern 7>) at step 218.

Further, if the determination at step 216 is “YES”, the process shifts to the process to return for error (see FIG. 18 <Pattern 3>) at step 218. If the determination at step 216 is “NO”, the process shifts to a process for the case the mail source is not playing game (see FIGS. 14 and 20 <Pattern 5>).

If the determination at step 212 is “YES”, the process shifts to a process to return for error (see FIG. 17 <Pattern 2> and FIG. 23 <Pattern 8>) at step 220. If the determination at step 212 is “NO”, the process shifts to a process for the case the mail source is not playing game and the address is non-registered (see FIGS. 15 and 21 <Pattern 6>).

At this moment, if the determination at step 212 is “NO”, the sender's address is the outside-game address such as “matsu@doco.co.jp” which is unregistered and when the user is not playing the game. This results in a situation the <Pattern 4> in FIG. 19 and the <Pattern 6> in FIG. 21 are not distinguished.

Incidentally, in the flowchart for the e-mail process in FIG. 12, the description of the sender's address does not correspond to the address of the hardware in the <pattern 3> in FIG. 18 or <Pattern 7> in FIG. 22.

<Pattern 3> in FIG. 18 and <Pattern 4> in FIG. 19 are the case when the e-mail was transmitted from the inside-game to outside-game address, which may be treated as an impossible case not to be taken into consideration.

Moreover, to determine whether the user is playing the game or not, the game server of the present invention is provided with the database as shown in FIG. 10, which includes the user identification information about the account ID the outside- and inside-game addresses stored at the initial registration of the player at step 106 in FIG. 11, and the information on the playing status of the user that is updated at the beginning and ending of the game. Although the updating of the playing status is not shown in the flowcharts, the user can recognize whose playing status has been changed by means of a configuration in which, for example, the account ID is issued by the game server at the initial registration of the user and the terminal of the user transmits the issued account ID at the beginning and ending of the game to be received by the game server.

The operation of the present invention is explained with reference a flowchart in FIG. 13 for the case the sender is playing the game (when using the dedicated e-mail address “001@”).

After entering into the process of <Pattern 1> for the sender in playing the game (using the dedicated e-mail address “001@”), that is the mail source is playing the game, a process for obtaining the destination address is executed at step 300, followed by a process for searching the data in the server at step 302, and a process to determine whether or not the destination address is registered at step 304.

If the determination at step 304 is “YES” (e.g. the destination address such as “eri@doco.co.jp” and “002@koei.co.jp” is a registered one), then a determination is made at step 306 as to whether the destination address is described as the inside-game address or not. If the determination at step 304 is “NO” (for example the destination address is “matsu@doco.co.jp” or “FFF@koei.co.jp” which is unregistered), another determination is made at step 308 as to whether the destination address is described as the inside-game address.

If the determination at step 306 is “YES” (e.g. the destination address is “002@koei.co.jp” which is the inside-game address), then a determination is made at step 310 as to whether the destination (i.e. receiver) is playing the game now. If the determination at step 306 is “NO” (e.g. the destination address is “eri@doco.co.jp” which is not the inside-game address), then a determination is made at step 312 as to whether the destination (i.e. receiver) is playing the game.

If the determination at step 310 is “YES”, then the destination address is converted (for example “eri@doco.co.jp” is converted to “002@koei.co.jp”) at step 314, followed by a process for storing and transferring the internal e-mail at step 316, and a process for return at step 334. If the determination at step 310 is “NO” (i.e. the destination address is improper), the destination address is converted (for example “002@koei.co.jp” is converted to “eri@doco.co.jp”), followed by a process for transmitting the external e-mail at step 320 and the process for return at step 334.

Further, if the determination at step 308 is “YES”, a process for a character ID error against “FFF@koei.co.jp” at step 322 and a process for return at step 326 are performed. If the determination at step 308 is “NO” (i.e. the sender knows the receiver's address), a process is performed at step 324 for transmission of the external e-mail which the e-mail is directly transmitted to “matsu@doco.oc.jp” without address conversion, followed by the process for return at step 326.

Further, if the determination at step 312 is “YES” (the destination address is improper), the destination address is converted (for example “eri@doco.co.jp” is converted to “002@koei.co.jp”) at step 328, followed by a process for storing and transferring the internal e-mail at step 330 and the process for return at step 334. If the determination at step 312 is “NO”, a process for transmitting the external e-mail is performed at step 332, followed by the process for return at step 334.

In the flowchart for the case the sender is playing the game (when using the dedicated e-mail address “001@”) in FIG. 13, the processes at steps 306, 312, 328, 330, and 332 enclosed by a dashed line can be omitted.

The operation of the present invention is explained with reference to a flowchart in FIG. 14 for the case the sender is not playing the game (when using the Internet e-mail address “ueno@”).

After entering into the process for the sender not playing the game (when using the Internet e-mail address “ueno@”), that is the process of <Pattern 5> where the mail source (i.e. sender) is not playing the game, a process for obtaining the destination address is performed at step 4[00, followed by a process for searching the data in the server at step 402. Then a determination is made at step 404 as to whether the destination address is registered or not.

If the determination at step 404 is “YES” (e.g. the destination address “002@koei.co.jp” is a registered one), then another determination is made at step 406 as to whether the destination address is described as the inside-game address. If the determination at step 404 is “NO” (e.g. the destination address “FFF@koei.co.jp” is not a registered one), then another determination is made at step 408 as to whether the destination address is described as the inside-game address.

If the determination at step 406 is “YES” (e.g. the destination address “002@koei.co.jp” is the inside-game address), then another determination is made at step 410 as to whether the destination (i.e. receiver) is playing the game. If the determination at step 406 is “NO” (e.g. the destination address “eri@doco.co.jp” is not the inside-game address), a process for transmitting the external e-mail is performed at step 412.

Incidentally, with regard to above-mentioned destination address “eri@doco.co.jp”, the mail source and destination are described as the outside-game, so that the e-mail never reaches the game server. On this account, the process at step 412 can be replaced by a process for error, not transmitting the e-mail.

If the determination at step 410 is “YES”, then the sender's address is converted (for example “ueno@doco.co.jp” is converted to “001@koei.co.jp”) at step 414, followed by a process for storing and transferring the internal e-mail at step 416 and a process for return at step 422. Further, if the determination at step 410 is “NO”, the sender's address is converted (for example “ueno@doco.co.jp” is converted to “001@koei.co.jp”) and the destination address is converted (for example “002@koei.co.jp” is converted to “eri@doco.co.jp”) at step 418, followed by a process for transmitting the external e-mail at step 420 and the process for return at step 422.

Further if the determination at step 408 is “YES”, a process for character ID error against “FFF@koei.co.jp” at step 424 and a process for return at step 426 are performed. If the determination at step 408 is “NO” (i.e. the sender knows the receiver's address), the process is performed at step 412 for direct transmission of external e-mail “matsu@doco.co.jp”, followed by the process for return at step 426. However, the mail source and destination are described as the outside-game, so that the e-mail never reaches the game server. On this account, the process at step 412 can be replaced by the process for error, not transmitting the e-mail.

Incidentally, in the flowchart for the case the sender is not playing the game (when using the Internet e-mail address “ueno@”) in FIG. 14, it is advantageous in that the users can exchange e-mails without being notified of other's Internet e-mail address irrespective of whether the use is inside or outside the game.

The above-mentioned process for storing and transferring the internal e-mail to the destination is performed through the Internet communication (transmission) by the HTTP (Hyper Text Transfer Protocol) or the protocol unique to the game after the e-mail is stored in the mail box of the receiver in the game server.

Further, the process for transmitting the external e-mail is performed to transmit to the external destination address through the mail server, after the e-mail is stored in the mail box of the receiver in the game server.

Moreover, the process for the character ID error is a process in which the error message is displayed on the terminal and the e-mail is not transmitted.

The operation of the present invention is explained with reference to the flowchart of FIG. 15 for the case the sender is not playing the game (when using the Internet e-mail address “matsu@”) and the sender's address is an unregistered one.

After entering into the process for case the sender is not playing the game (when using the unregistered Internet e-mail address “matsu@”), that is the process of <Pattern 6> where the mail source is not playing the game and the address is unregistered, a process for obtaining the destination address is performed at step 5[00, followed by a process for searching the data in the server at step 502. Then a determination is made at step 504 as to whether the destination address is registered or not.

If the determination at step 504 is “YES” (e.g. destination address “002@koei.co.jp” is a registered one), then another determination is made at step 506 as to whether the destination is described as the inside-game address. If the determination at step 504 is “NO” (e.g. the destination address “FFF@koei.co.jp” is not a registered one), then another determination is made at step 508 as to whether the destination address is described as the inside-game address.

If the determination at step 506 is “YES” (e.g. the destination address “002@koei.co.jp” is the inside-game address), then a determination is made at step 510 as to whether the destination (i.e. receiver) is playing the game. If the determination at step 506 is “NO” (e.g. the destination address “eri@doco.co.jp” is not the inside-game address), a process for transmitting the external e-mail is performed at step 512.

Incidentally, the mail source and destination are described as the outside-game, so that the e-mail never reaches the game server. On this account, the process at step 512 can be replaced by a process for error, not transmitting the e-mail.

If the determination at step 510 is “YES”, the sender's address is converted (for example “matsu@doco.co.jp” is converted to “guest@koei.co.jp”) at step 514, followed by a process for storing and transferring the internal e-mail at step 516 and a process for return at step 522. Further, if the determination at step 510 is “NO”, the sender's address is converted (for example “matsu@doco.co.jp” is converted to “guest@koei.co.jp”) and the destination address is converted (for example “002@koei.co.jp” is converted to “eri@doco.co.jp”) at step 518, followed by a process for transmitting the external e-mail at step 520 and the process for return at step 522.

Further if the determination at step 508 is “YES”, a process for a character ID error against “FFF@koei.co.jp” at step 524 and a process for return at step 526 are performed. If the determination at step 508 is “NO” (i.e. the sender knows the receiver's address), the process is performed at step 512 for direct transmission of external e-mail “usa@doco.co.jp”, followed by the process for return at step 526. However, the mail source and destination are described as the outside-game, so that the e-mail never reaches the game server. On this account, the process at step 512 can be replaced by a process for error, not transmitting the e-mail.

Accordingly, by the e-mail feature acting as the important role of communication in the multi-participant MMORPG type network game, the players on the network game can have more opportunity for communication, owing to association between the instant e-mail feature to be used in the network game routing through the dedicated server and the nearly-instant e-mail feature to be used outside the network game not routing through the dedicated server.

In addition, the e-mail community system 2 converts the Internet e-mail address, which is the private e-mail address, and the dedicated e-mail address, which includes the character ID of the network game, thereby avoiding the personal information to leak for safe communications.

In addition, the present invention provides the effects as follows. (1) For the transmission of the e-mail from the inside to outside game, the communication can be established with the user who is not playing the game at present. (2) For the transmission of the e-mail from the outside to inside game, the user who cannot log in the game server at an inconvenient time can communicate with the other user who is now playing the game. (3) In case some trouble arose between the friendly users, the possibility that the troublesome user stalks or sends Internet e-mail to the other user can be reduced. According to the present invention, irrespective of whether the sender or receiver is playing the game or not (inside game or outside game), the e-mail address is automatically converted according to the present state (whenever the user is inside or outside the game) to perform transmission/reception without notifying of the private e-mail address to the opponent.

The present invention is not limited to above-mentioned embodiment and the modifications and changes can be made.

For example, in the MMORPG network game, in communicating the player 1 operating the first terminal who plays a key role in the network game with the player 2 operating the second terminal, the embodiment of the present invention provides the structure in which the two terminal (first and second terminals) are connected to the dedicated server provided by the network game provider. Due to the fact that many players can join the game in the MMORPG network game, a system for communication among more than three characters is achievable when a third terminal and others are connected to the dedicated server.

It is apparent that not only the players 1 and 2 but also three or more players can join the game, since a number of players, such as thousands player, can join the game in the network game of the MMORPG type. One can make a prediction that many characters joined the game communicate each other.

Accordingly, the opportunity for communication among more than three players increases without limitation to the number of the players who can join the game, which contributes to activation of the network game of the MMORPG type. The e-mail community system converts the Internet e-mail address (private e-mail address) and the dedicated e-mail address containing the inside-game character ID to prevent the private information of the three or more players from leaking.

### EXPLANATION OF REFERENCE NUMERALS

2 e-mail community system; 4 dedicated server 4 (also referred to as “game server” or simply “server”); 6 first terminal equipment; 8 second terminal equipment; 10 Internet; 12 first internet service provider (ISP1); 14 second Internet service provider (ISP2); 16 third Internet service provider (ISP3); 18 first mail server (mail server 1); 20 second mail server (mail server 2); 22 third mail server (mail server 3); 24 public line network; and 26 mobile terminal.

1. An e-mail community system wherein, in a multiple-participant network game which the network game proceeds by intensively administrating the virtual space shared by a dedicated server and each terminal equipment and by transmission/reception between the dedicated server and the terminal equipment,
as the network game proceeds by operating a character displayed in the virtual space as an avatar representing the player himself of one terminal equipment, the players on the terminal equipment can communicate each other by using dedicated e-mail addresses that can be used only in the network game, comprising the step of:
in communicating between the terminal equipment, when a sender uses the dedicated e-mail address routing through the dedicated server, permitting a receiver to transmit/receive the e-mail with the dedicated e-mail address routing through the dedicated server or with the Internet e-mail address not routing through the dedicated server; and
in communicating between the terminal equipment, when the sender uses the Internet e-mail address not routing through the dedicated server, permitting the receiver to transmit/receive the e-mail with the dedicated e-mail address routing through the dedicated server by converting automatically the Internet e-mail address into the dedicated e-mail address.

2. A program for controlling an e-mail community system wherein, in a multiple-participant network game which the network game proceeds by intensively administrating the virtual space shared by a dedicated server and each terminal equipment and by transmission/reception between the dedicated server and the terminal equipment,
as the network game proceeds by operating a character displayed in the virtual space as an avatar representing the player himself of one terminal equipment, the e-mail community system which permits the players on the terminal equipment to communicate each other by using dedicated e-mail addresses that can be used only in the network game, comprising:
in communicating between the terminal equipment, when a sender uses the dedicated e-mail address routing through the dedicated server, means for permitting a receiver to transmit/receive the e-mail with the dedicated e-mail address routing through the dedicated server or with the Internet e-mail address not routing through the dedicated server; and
in communicating between the terminal equipment, when the sender uses the Internet e-mail address not routing through the dedicated server, means for permitting the receiver to transmit/receive the e-mail with the dedicated e-mail address routing through the dedicated server by converting automatically the Internet e-mail address into the dedicated e-mail address.

3. A computer-readable recording medium on which the program defined in claim 2 is recorded.

4. A computer-readable recording medium on which the program defined in claim 1 is recorded.
